(19) United States
(12) Patent Application Publication
(10) Pub. No.: US 2016/0350284 A1
(43) Pub. Date: Dec. 1, 2016

(54) ELECTRONIC COMMUNITY-BASED TRANSLATION SERVICE

(71) Applicant: ABBYY Development LLC, Moscow (RU)

(72) Inventors: David Yan, Portola Valley, CA (US); Maria Osipova, Moscow (RU)

(21) Appl. No.: 14/855,638

(22) Filed: Sep. 16, 2015

(30) Foreign Application Priority Data
May 25, 2015 (RU) 2015119583

(51) Int. Cl. G06F 17/28; H04L 12/58

(52) U.S. Cl. CPC G06F 17/28; H04L 51/16; H04L 51/32

(57) ABSTRACT

The current document is directed to an electronic community-based translation service that includes a distributed computer system, electronic communications media and infrastructure, multiple user processor-controlled devices, and control components that control the distributed computer system, communications infrastructure, and processor-controlled user devices to provide an electronic community in which users can view and access translations, search for translations, and provide translations. Because the translation service is community-based, users accessing translations are able to determine various characteristics associated with community-provided translations and those who provide them. In addition, users can follow community use of translations, including determining who has used community-provided translations, shared community-provided translations with others, and rated translations.

### CROSS REFERENCE TO RELATED APPLICATIONS

The present application claims the benefit of priority under 35 USC 119 to Russian Patent Application No. 2015119583, filed May 25, 2015; the disclosure of which is incorporated herein by reference in its entirety.

### TECHNICAL FIELD

The current document is directed to natural-language translation and, in particular, to an electronic infrastructure that supports a community of users who electronically access and provide translations of words and phrases.

### BACKGROUND

As electronic communications and computer technologies have evolved, during the past 60 years, a variety of Internet-enabled communications systems and information-distribution services have become available to facilitate communications and exchange of information between large numbers of geographically dispersed users. These services include various online resources, such as Wikipedia and YouTube, as well as a variety of different social-networking services, including Facebook.

With the advent of global electronic communications, interest in language translation and language-translation services has increased. Numerous online dictionaries and translation services have been developed to facilitate translation of emails, documents, electronic messages, and electronically transmitted audio files containing spoken words and phrases. While many of these services provide for translation of words and phrases from one language to another, they lack features to allow a community of users to cooperate in constructing and furthering the evolution of an electronic community-based translation service. Students of languages, teachers and translators of languages, and those who use multiple languages in the course of personal or business-related activities continue to seek easy-to-use, verifiable, and comprehensive translation services in the evolution of which they can participate.

### SUMMARY

The current document is directed to an electronic community-based translation service that includes a distributed computer system, electronic communications media and infrastructure, multiple user processor-controlled devices, and control components that control the distributed computer system, communications infrastructure, and processor-controlled user devices to provide an electronic community in which users can view and access translations, search for translations, and provide translations. Because the translation service is community-based, users accessing translations are able to determine various characteristics associated with community-provided translations and those who provide them. In addition, users can follow community use of translations, including determining who has used community-provided translations, shared community-provided translations with others, and rated translations. The electronic community-based translation service allows users to comment on translations as well as to provide their own translations. In many implementations, human moderators and/or automated verification subsystems cooperate to authenticate and verify users, user statuses, the levels of mastery of languages of users, and other such characteristics and parameters. In certain implementations, the electronic community-based translation service provides message-posting facilities, similar to those provided by social networks, as well as translation-search facilities.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIG. 5A illustrates two types of virtual machine and virtual-machine execution environments.

FIG. 5B illustrates two types of virtual machine and virtual-machine execution environments.

FIG. 6 illustrates electronic communications between a client and server computer.

FIG. 7 illustrates the role of resources in RESTful APIs.

FIG. 8A illustrates four basic verbs, or operations, provided by the HTTP application-layer protocol used in RESTful applications.

FIG. 8B illustrates four basic verbs, or operations, provided by the HTTP application-layer protocol used in RESTful applications.

FIG. 8C illustrates four basic verbs, or operations, provided by the HTTP application-layer protocol used in RESTful applications.

FIG. 8D illustrates four basic verbs, or operations, provided by the HTTP application-layer protocol used in RESTful applications.

FIG. 9A illustrates a landing page for one implementation of the electronic community-based translation service, displayed by a web browser running on a processed-controlled user device, and numerous features provided by the landing page.

FIG. 9B illustrates a landing page for one implementation of the electronic community-based translation service, displayed by a web browser running on a processed-controlled user device, and numerous features provided by the landing page.

FIG. 9C illustrates a landing page for one implementation of the electronic community-based translation service, displayed by a web browser running on a processed-controlled user device, and numerous features provided by the landing page.

FIG. 9D illustrates a landing page for one implementation of the electronic community-based translation service, displayed by a web browser running on a processed-controlled user device, and numerous features provided by the landing page.

FIG. 9E illustrates a landing page for one implementation of the electronic community-based translation service, displayed by a web browser running on a processed-controlled user device, and numerous features provided by the landing page.

FIG. 9F illustrates a landing page for one implementation of the electronic community-based translation service, displayed by a web browser running on a processed-controlled user device, and numerous features provided by the landing page.

FIG. 9G illustrates a landing page for one implementation of the electronic community-based translation service, displayed by a web browser running on a processed-controlled user device, and numerous features provided by the landing page.

FIG. 10 illustrates the overall hardware-level and communications-infrastructure-level architecture of one implementation of the electronic community-based translation service.

FIG. 11A illustrates the general implementation of the control subsystems within the electronic community-based translation service.

FIG. 11B illustrates the general implementation of the control subsystems within the electronic community-based translation service.

FIG. 11C illustrates the general implementation of the control subsystems within the electronic community-based translation service.

FIG. 12 illustrates how the browser application on a processor-controlled user device is controlled by the electronic community-based translation service to provide the interactive user interface by which users post requests for translations, translations, and general messages to the community of electronic-community-based translation-service users.

FIG. 13 illustrates the data component of the client and server portions of the electronic community-based translation service.

FIG. 14A illustrates using control-flow diagrams, one implementation of the electronic community-based translation service to which the current document is directed.

FIG. 14B illustrates using control-flow diagrams, one implementation of the electronic community-based translation service to which the current document is directed.

FIG. 14C illustrates using control-flow diagrams, one implementation of the electronic community-based translation service to which the current document is directed.

FIG. 14D illustrates using control-flow diagrams, one implementation of the electronic community-based translation service to which the current document is directed.

FIG. 14E illustrates using control-flow diagrams, one implementation of the electronic community-based translation service to which the current document is directed.

FIG. 14F illustrates using control-flow diagrams, one implementation of the electronic community-based translation service to which the current document is directed.

FIG. 14G illustrates using control-flow diagrams, one implementation of the electronic community-based translation service to which the current document is directed.

FIG. 14H illustrates using control-flow diagrams, one implementation of the electronic community-based translation service to which the current document is directed.

FIG. 14I illustrates using control-flow diagrams, one implementation of the electronic community-based translation service to which the current document is directed.

FIG. 14J illustrates using control-flow diagrams, one implementation of the electronic community-based translation service to which the current document is directed.

FIG. 15A illustrates computation of an initial rating for a posted translation, carried out by the call to the function “assign initial rating” in step 1488 of FIG. 14I.

FIG. 15B illustrates examples of relational database tables that may be used, in certain implementations, to store data within the distributed computing system that includes web servers that host the electronic community-based translation service web site.

FIG. 15C illustrates examples of relational database tables that may be used, in certain implementations, to store data within the distributed computing system that includes web servers that host the electronic community-based translation service web site.

### DETAILED DESCRIPTION

The current document is directed to an electronic community-based translation service. In one implementation, the electronic community-based translation service includes a distributed computer system, multiple processor-controlled user devices, a communications infrastructure that provides for exchange of electronic data between the processor-controlled user devices and distributed computer system, and control components that control the electronic community-based translation service to provide facilities for accessing, rating, commenting on, and providing translations of words and phrases from one language to another. The electronic community-based translation service is a complex combination of computers, processor-controlled devices, communications facilities, and control components, many of which are partly implemented by electronically stored computer instructions executed on one or more processors of the processor-controlled user devices and distributed computing system. The electronic community-based translation service is a physical system that includes physical processor-controlled devices, physical computer systems, physical processor-controlled devices, and physical control components. In a first subsection, below, a brief overview of computers, operating systems, virtualization layers, electronic communications, and electronic-communications protocols is provided. A second subsection provides a detailed description of many of the features as well as the user interface of one implementation of the electronic community-based translation service. A third subsection provides a detailed discussion of one implementation of the electronic community-based translation service.

### Brief Overview of Computers and Electronic Communications

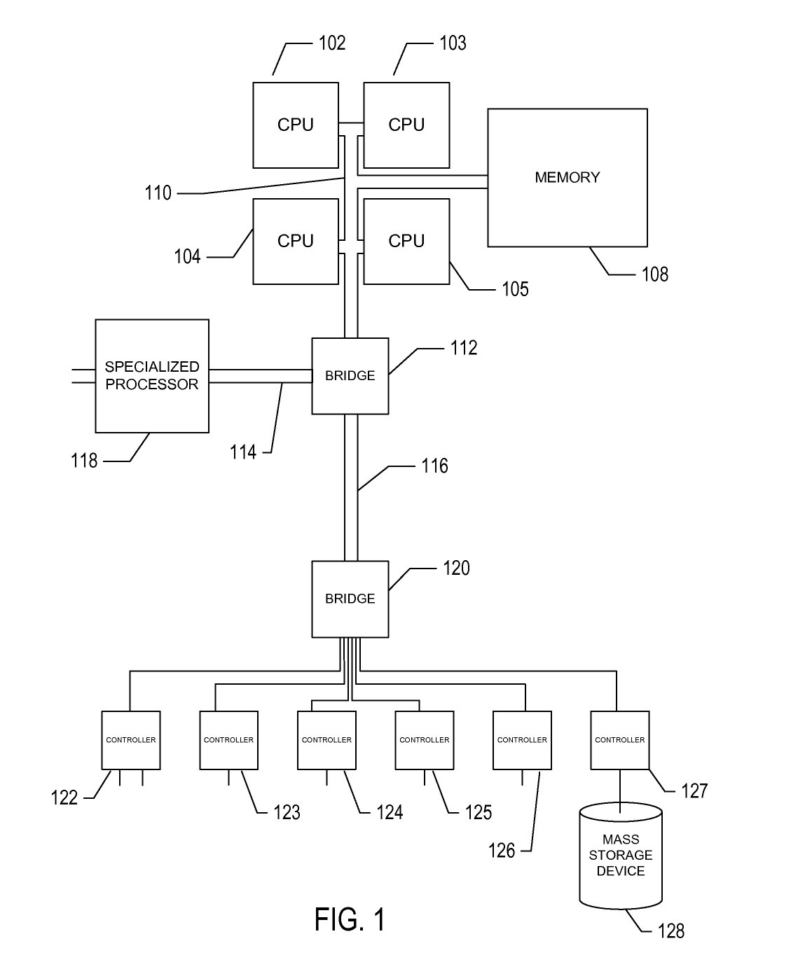

FIG. 1 provides a general architectural diagram for various types of computers. Web servers and user computers that run browser applications may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

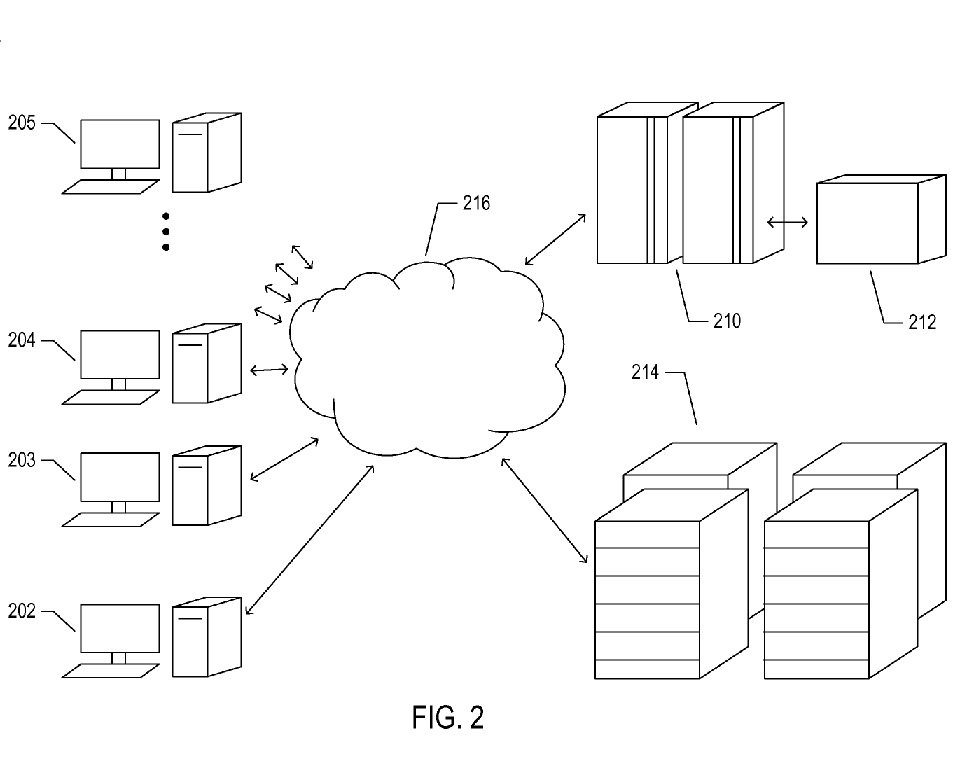

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

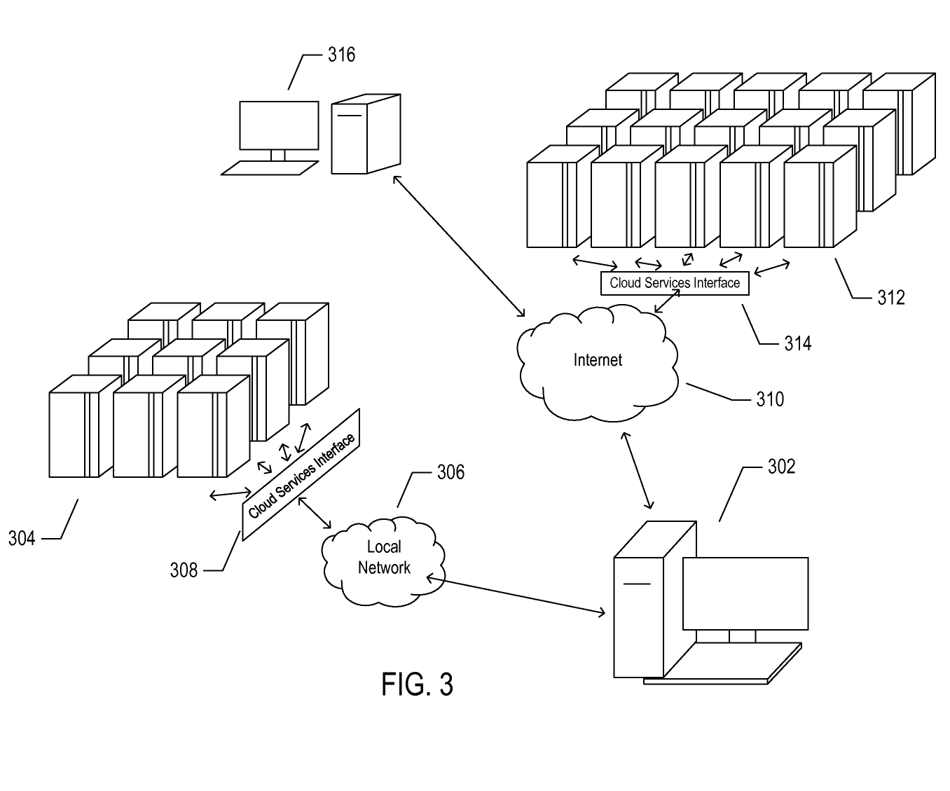

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

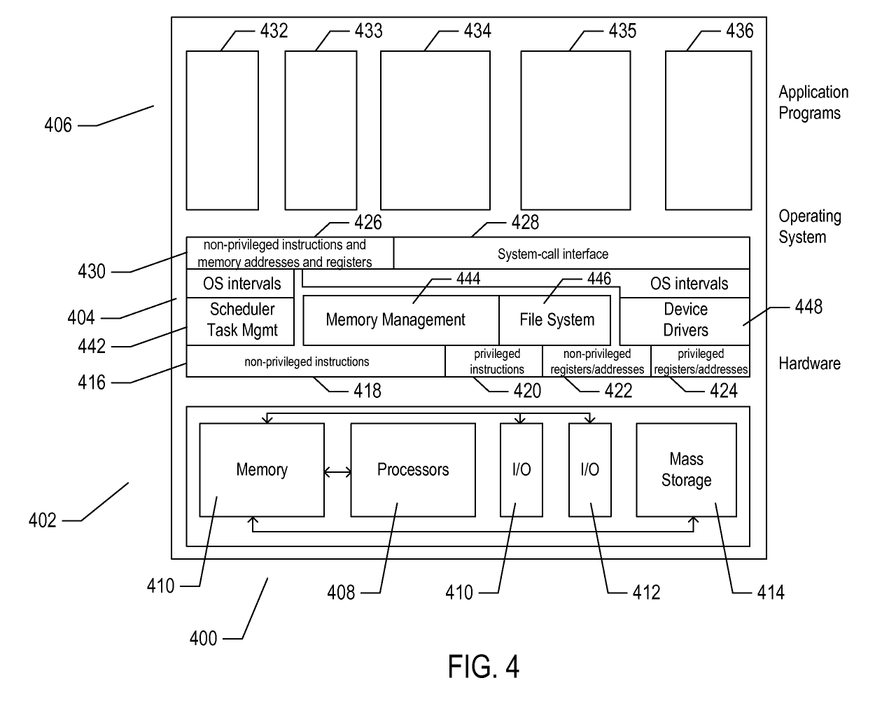

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

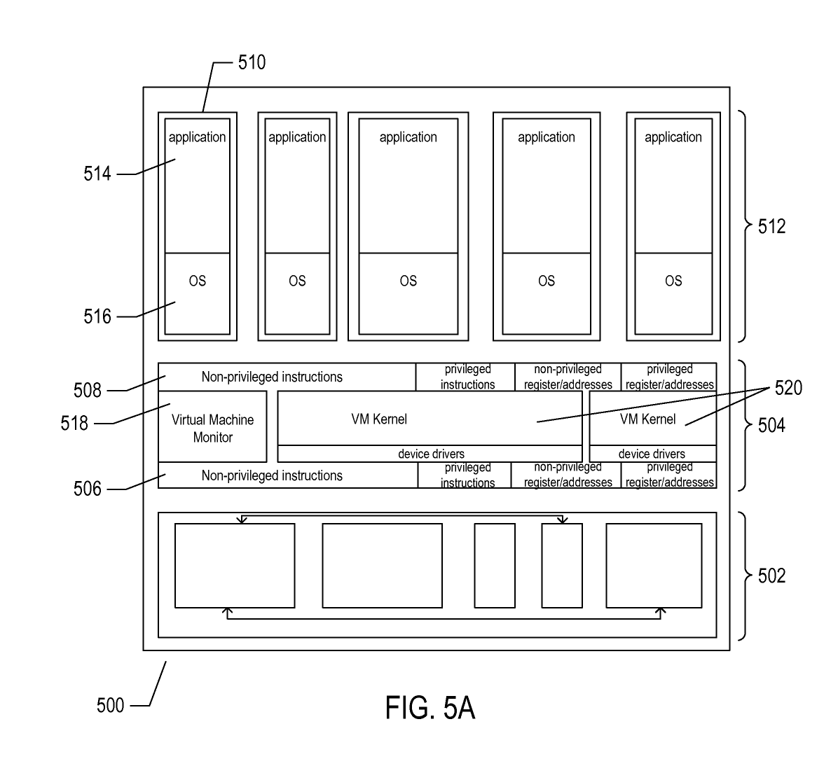

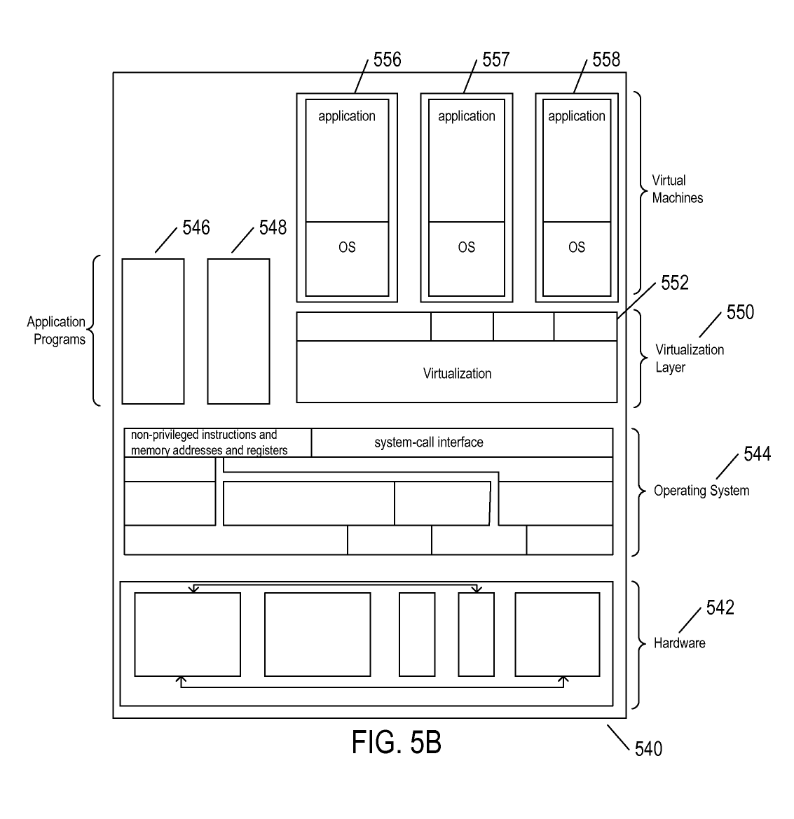

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

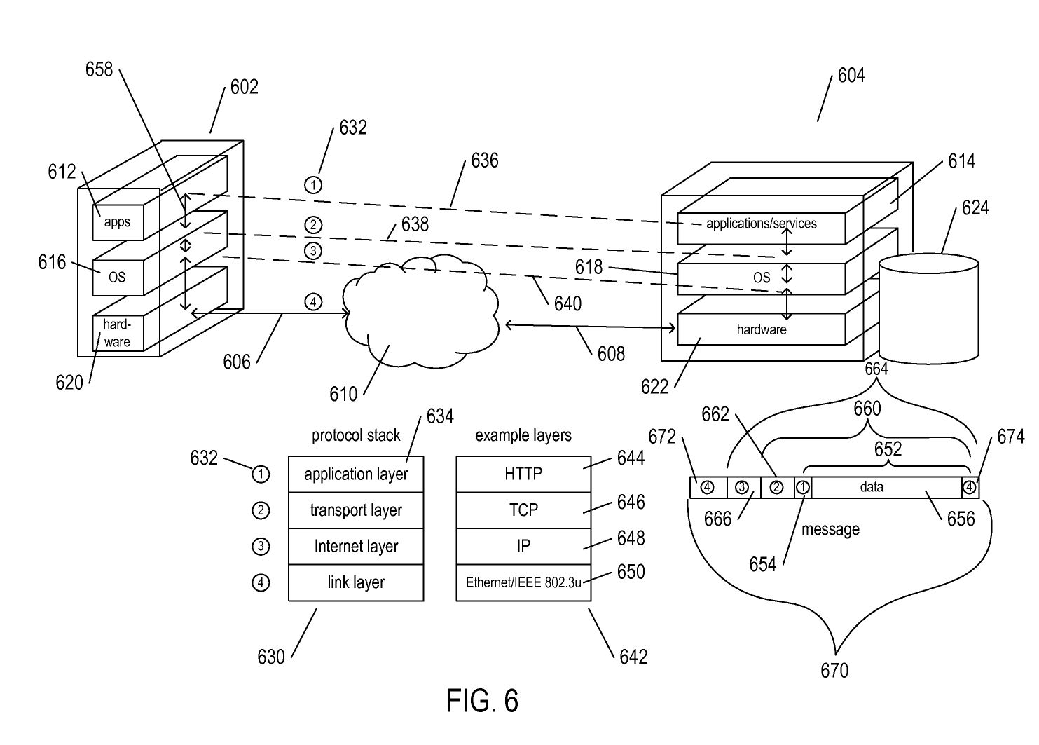

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” In FIG. 6, a representation of a common protocol stack 630 is shown below the interconnected server and client computers (604 and 602). The layers are associated with layer numbers, such as layer number “1” 632 associated with the application layer 634. These same layer numbers are used in the depiction of the interconnection of the client computer 602 with the server computer 604, such as layer number “1” 632 associated with a horizontal dashed line 636 that represents interconnection of the application layer 612 of the client computer with the applications/services layer 614 of the server computer through an application-layer protocol. A dashed line 636 represents interconnection via the application-layer protocol in FIG. 6, because this interconnection is logical, rather than physical. Dashed-line 638 represents the logical interconnection of the operating-system layers of the client and server computers via a transport layer. Dashed line 640 represents the logical interconnection of the operating systems of the two computer systems via an Internet-layer protocol. Finally, links 606 and 608 and cloud 610 together represent the physical communications media and components that physically transfer data from the client computer to the server computer and from the server computer to the client computer. These physical communications components and media transfer data according to a link-layer protocol. In FIG. 6, a second table 642 aligned with the table 630 that illustrates the protocol stack includes example protocols that may be used for each of the different protocol layers. The hypertext transfer protocol (“HTTP”) 644 may be used as the application-layer protocol, the transmission control protocol (“TCP”) 646 may be used as the transport-layer protocol, the Internet protocol 648 (“IP”) may be used as the Internet-layer protocol, and, in the case of a computer system interconnected through a local Ethernet to the Internet, the Ethernet/IEEE 802.3u protocol 650 may be used for transmitting and receiving information from the computer system to the complex communications components of the Internet. Within cloud 610, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 652. The datagram may generally include a header 654 as well as the data 656, encoded as a sequence of bytes within a block of memory. The header 654 is generally a record composed of multiple byte-encoded fields. The call by the application program to an application-layer system call is represented in FIG. 6 by solid vertical arrow 658. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 660 includes a transport-layer-message header 662 and an application-layer datagram 652. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 664, each including an Internet-layer header 666 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 664 into a link-layer datagram 670 that includes a link-layer header 672 and generally includes a number of additional bytes 674 appended to the end of the Internet-layer datagram. The link-layer header includes collision-control and error-control information as well as local-network addresses. The link-layer packet or datagram 670 is a sequence of bytes that includes information introduced by each of the layers of the protocol stack as well as the actual data that is transferred from the source computer to the destination computer according to the application-layer protocol.

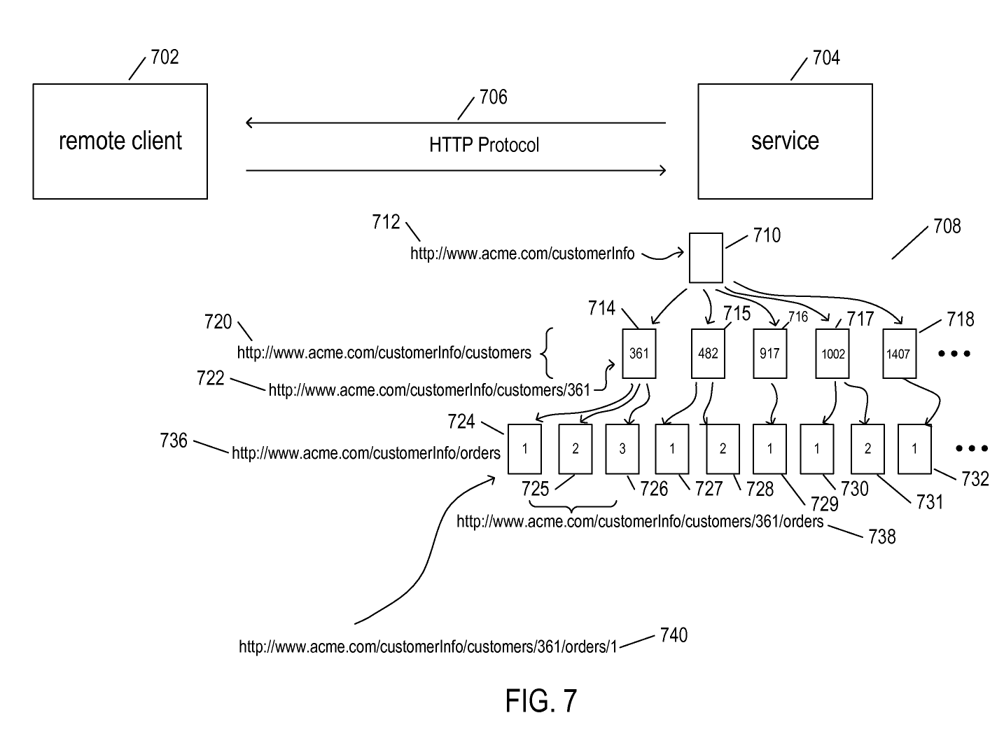

Next, the RESTful approach to web-service APIs is described, beginning with FIG. 7. FIG. 7 illustrates the role of resources in RESTful APIs. In FIG. 7, and in subsequent figures, a remote client 702 is shown to be interconnected and communicating with a service provided by one or more server computers 704 via the HTTP protocol 706. Many RESTful APIs are based on the HTTP protocol. Thus, the focus is on the application layer in the following discussion. However, as discussed above with reference to FIG. 7, the remote client 702 and service provided by one or more server computers 704 are, in fact, physical systems with application, operating-system, and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers, as discussed above in a preceding section. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people, digitally encoded documents, organizations, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 7, the web servers 704 provides a RESTful API based on the HTTP protocol 706 and a hierarchically organized set of resources 708 that allow clients of the service to access information about the customers and orders placed by customers of the Acme Company. This service may be provided by the Acme Company itself or by a third-party information provider. All of the customer and order information is collectively represented by a customer information resource 710 associated with the URI “http://www.acme.com/customerInfo” 712. As discussed further, below, this single URI and the HTTP protocol together provide sufficient information for a remote client computer to access any of the particular types of customer and order information stored and distributed by the service 704. A customer information resource 710 represents a large number of subordinate resources. These subordinate resources include, for each of the customers of the Acme Company, a customer resource, such as customer resource 714. All of the customer resources 714-718 are collectively named or specified by the single URI “http://www.acme.com/customerInfo/customers” 720. Individual customer resources, such as customer resource 714, are associated with customer-identifier numbers and are each separately addressable by customer-resource-specific URIs, such as URI “http://www.acme.com/customerInfo/customers/361” 722 which includes the customer identifier “361” for the customer represented by customer resource 714. Each customer may be logically associated with one or more orders. For example, the customer represented by customer resource 714 is associated with three different orders 724-726, each represented by an order resource. All of the orders are collectively specified or named by a single URI “http://www.acme.com/customerInfo/orders” 736. All of the orders associated with the customer represented by resource 714, orders represented by order resources 724-726, can be collectively specified by the URI “http://www.acme.com/customerInfo/customers/361/orders” 738. A particular order, such as the order represented by order resource 724, may be specified by a unique URI associated with that order, such as URI “http://www.acme.com/customerInfo/customers/361/orders/1” 740, where the final “1” is an order number that specifies a particular order within the set of orders corresponding to the particular customer identified by the customer identifier “361.” In one sense, the URIs bear similarity to path names to files in file directories provided by computer operating systems. However, it should be appreciated that resources, unlike files, are logical entities rather than physical entities, such as the set of stored bytes that together compose a file within a computer system. When a file is accessed through a path name, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a path name, the representation of a resource is not a copy of the resource, but is instead some type of digitally encoded information with respect to the resource.

In the example RESTful API illustrated in FIG. 7, a client computer can use the verbs, or operations, of the HTTP protocol and the top-level URI 712 to navigate the entire hierarchy of resources 708 in order to obtain information about particular customers and about the orders that have been placed by particular customers.

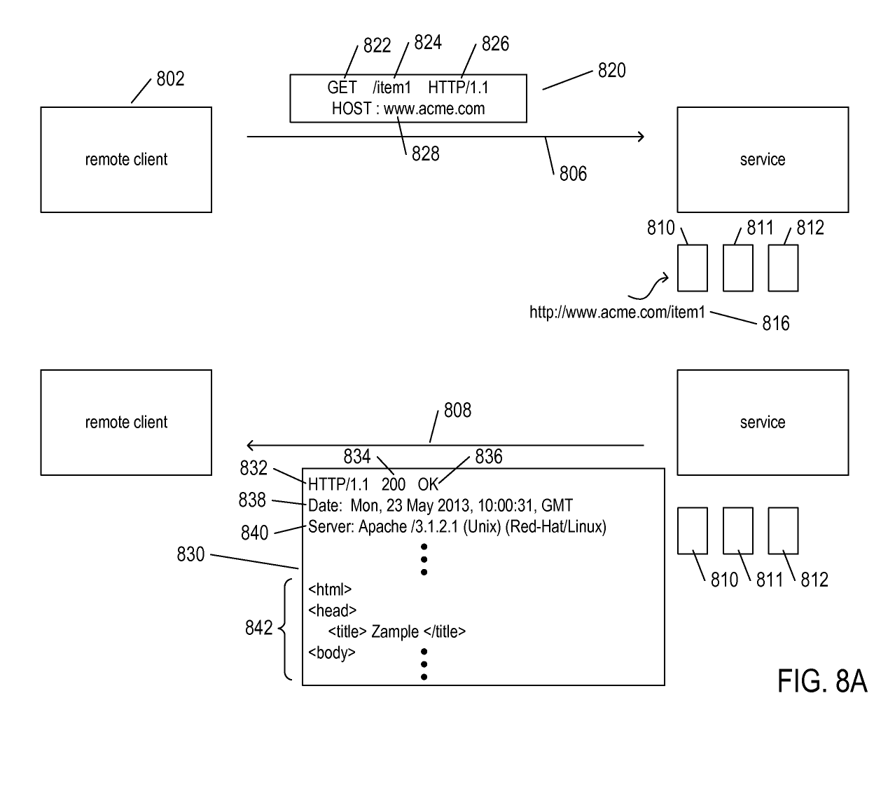

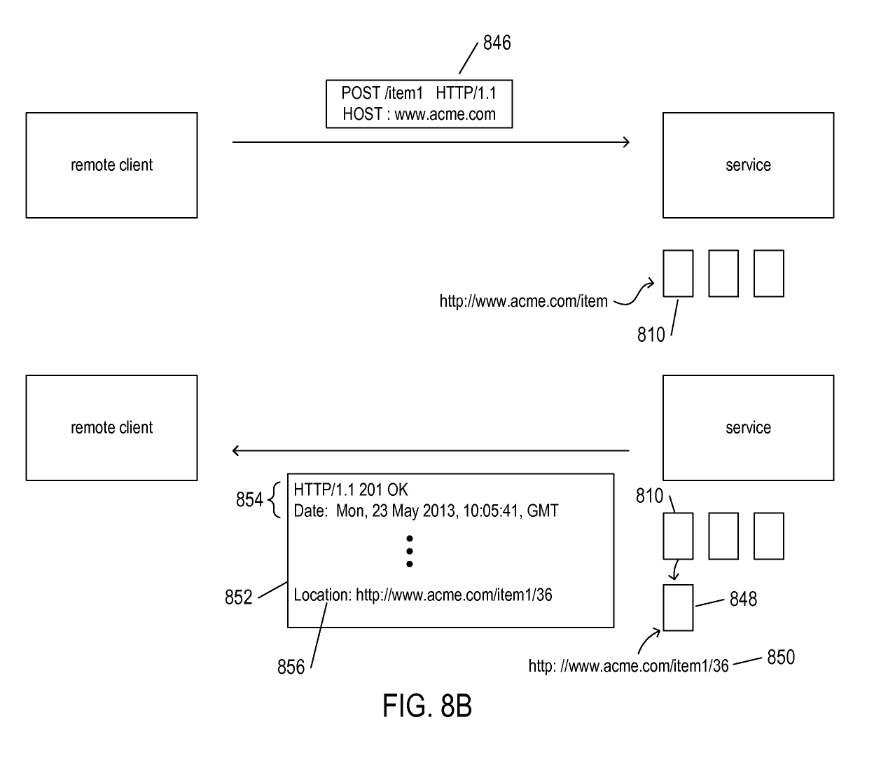

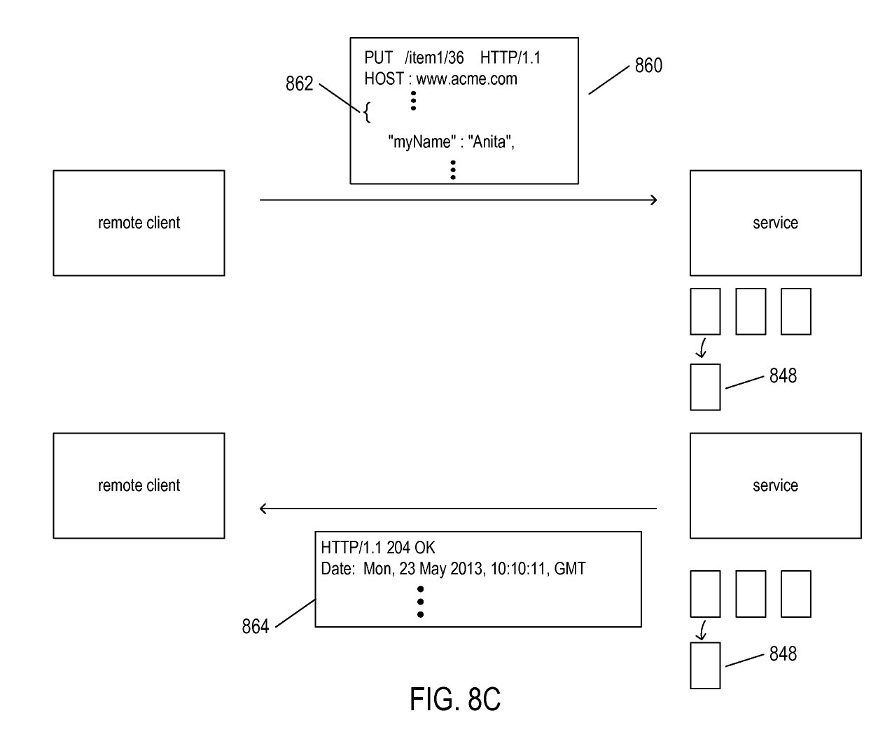

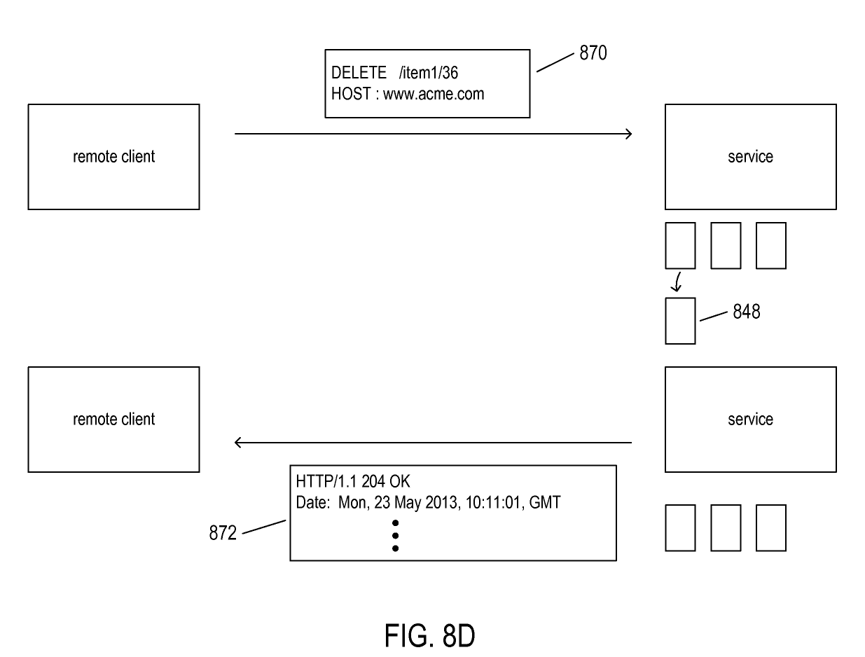

FIGS. 8A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 8A-D use the illustration conventions discussed above with reference to FIG. 7 with regard to the client, service, and HTTP protocol. For simplicity and clarity of illustration, in each of these figures, a top portion illustrates the request and a lower portion illustrates the response. The remote client 802 and service 804 are shown as labeled rectangles, as in FIG. 7. A right-pointing solid arrow 806 represents sending of an HTTP request message from a remote client to the service and a left-pointing solid arrow 808 represents sending of a response message corresponding to the request message by the service to the remote client. For clarity and simplicity of illustration, the service 804 is shown associated with a few resources 810-812.

FIG. 8A illustrates the GET request and a typical response. The GET request requests the representation of a resource identified by a URI from a service. In the example shown in FIG. 8A, the resource 810 is uniquely identified by the URI “http://www.acme.com/item1” 816. The initial substring “http://www.acme.com” is a domain name that identifies the service. Thus, URI 816 can be thought of as specifying the resource “item1” that is located within and managed by the domain “www.acme.com.” The GET request 820 includes the command “GET” 822, a relative resource identifier 824 that, when appended to the domain name, generates the URI that uniquely identifies the resource, and in an indication of the particular underlying application-layer protocol 826. A request message may include one or more headers, or key/value pairs, such as the host header 828 “Host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 830. The response message includes an indication of the application-layer protocol 832, a numeric status 834, a textual status 836, various headers 838 and 840, and, in the current example, a body 842 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 8B illustrates the POST HTTP verb. In FIG. 8B, the client sends a POST request 846 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 8B, the service creates a new resource 848 subordinate to resource 810 specified by URI “http://www.acme.com/item1,” and assigns an identifier “36” to this new resource, creating for the new resource the unique URI “http://www.acme.com/item1/36” 850. The service then transmits a response message 852 corresponding to the POST request back to the remote client. In addition to the application-layer protocol, status, and headers 854, the response message includes a location header 856 with the URI of the newly created resource. According to the HTTP protocol, the POST verb may also be used to update existing resources by including a body with update information. However, RESTful APIs generally use POST for creation of new resources when the names for the new resources are determined by the service. The POST request 846 may include a body containing a representation or partial representation of the resource that may be incorporated into stored information for the resource by the service.

FIG. 8C illustrates the PUT HTTP verb. In RESTful APIs, the PUT HTTP verb is generally used for updating existing resources or for creating new resources when the name for the new resources is determined by the client, rather than the service. In the example shown in FIG. 8C, the remote client issues a PUT HTTP request 860 with respect to the URI “http://www.acme.com/item1/36” that names the newly created resource 848. The PUT request message includes a body with a JSON encoding of a representation or partial representation of the resource 862. In response to receiving this request, the service updates resource 848 to include the information 862 transmitted in the PUT request and then returns a response corresponding to the PUT request 864 to the remote client.

FIG. 8D illustrates the DELETE HTTP verb. In the example shown in FIG. 8D, the remote client transmits a DELETE HTTP request 870 with respect to URI “http://www.acme.com/item1/36” that uniquely specifies newly created resource 848 to the service. In response, the service deletes the resource associated with the URL and returns a response message 872.

As further discussed below, and as mentioned above, a service may return, in response messages, various different links, or URIs, in addition to a resource representation. These links may indicate, to the client, additional resources related in various different ways to the resource specified by the URI associated with the corresponding request message. As one example, when the information returned to a client in response to a request is too large for a single HTTP response message, it may be divided into pages, with the first page returned along with additional links, or URIs, that allow the client to retrieve the remaining pages using additional GET requests. As another example, in response to an initial GET request for the customer info resource (710 in FIG. 7), the service may provide URIs 720 and 736 in addition to a requested representation to the client, using which the client may begin to traverse the hierarchical resource organization in subsequent GET requests.

The above-provided background information is intended to describe the hardware and communications infrastructure within which an electronic-community-based translation service is constructed, in many implementations. Of course, the hardware and communications infrastructure is quite complex and can only be described in the current document in overview.

A Description of the User Interface of, and Services Provided by, One Implementation of the Electronic Community-Based Translation Service to which the Current Document is Directed

In one implementation of the electronic community-based translation service, users, or community members, access the electronic community-based translation service via a thin client (for example, a browser application) running on the user's processor-controlled device, such as a laptop, desktop, notebook, or smartphone. In this implementation, the electronic community-based translation service comprises a web site served by one or more web servers, generally incorporated within a large distributed-computing facility, such as a cloud-computing facility.

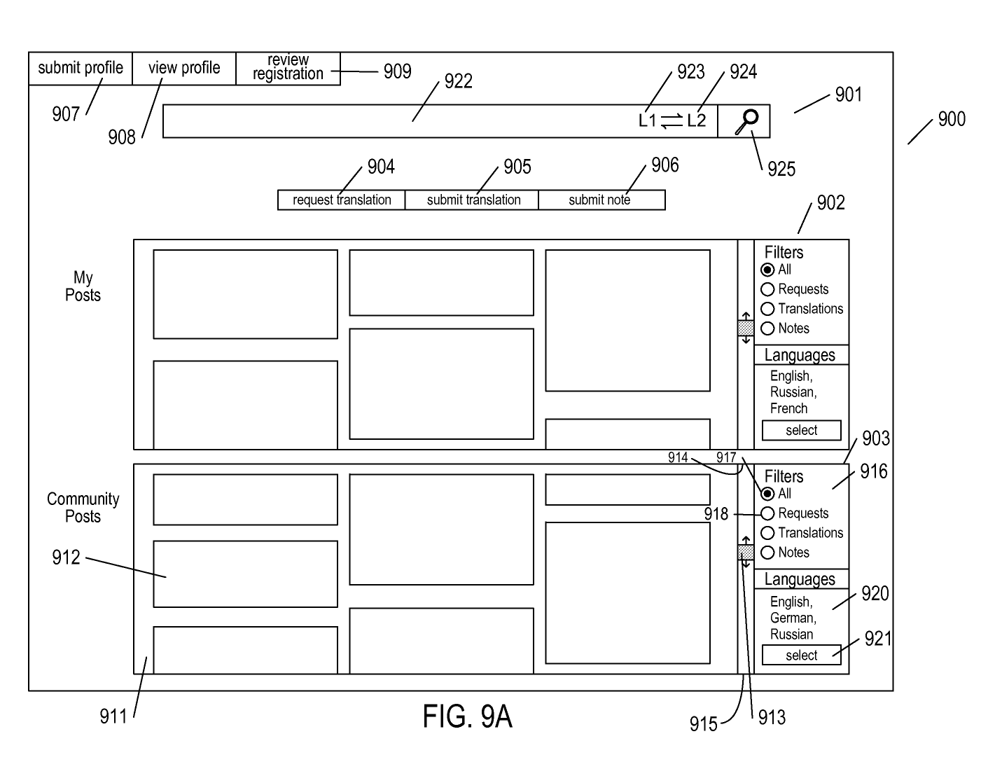

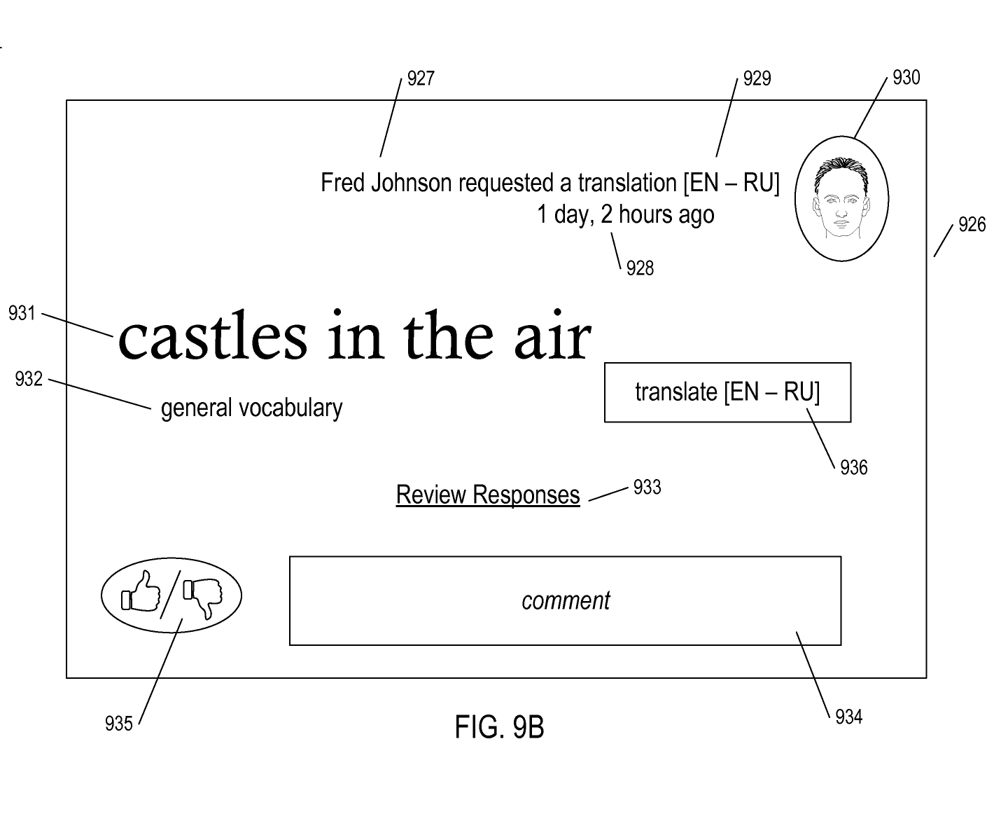

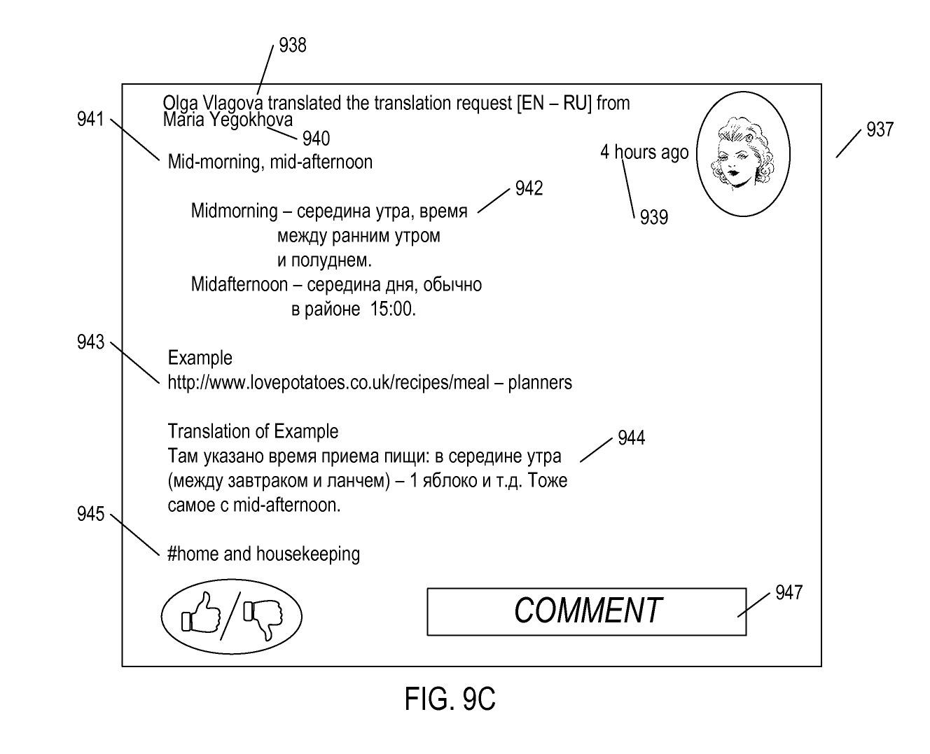

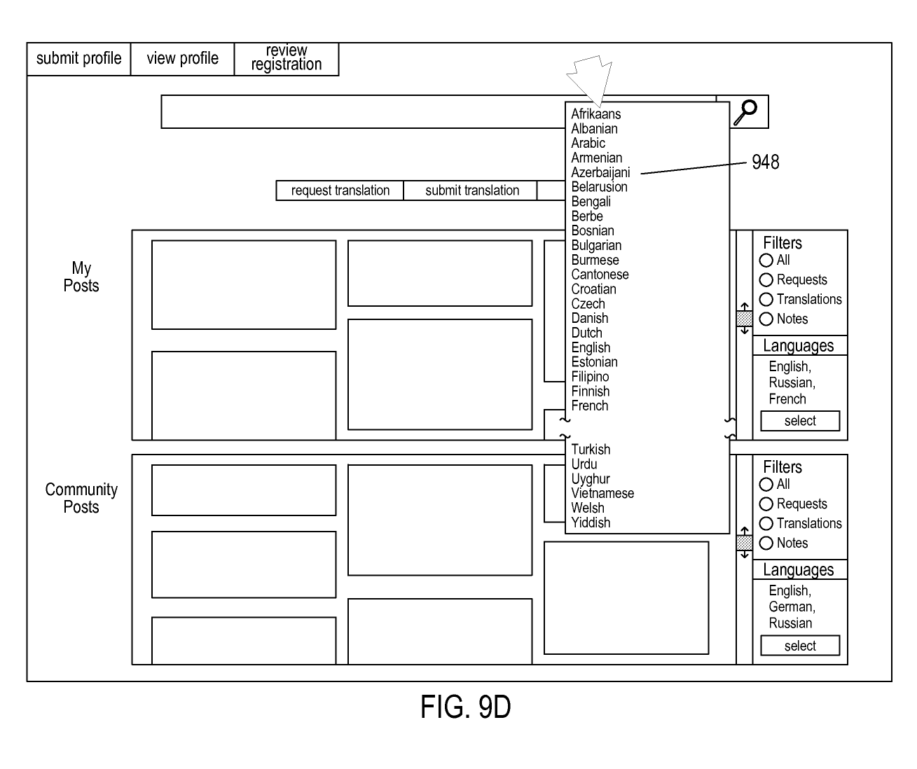

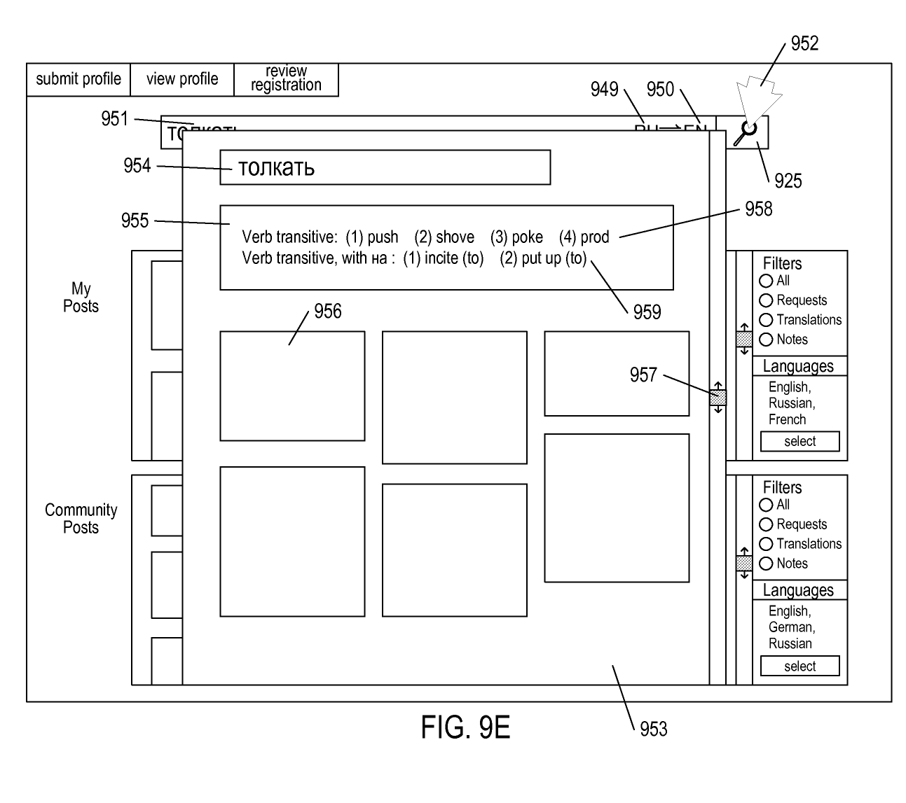

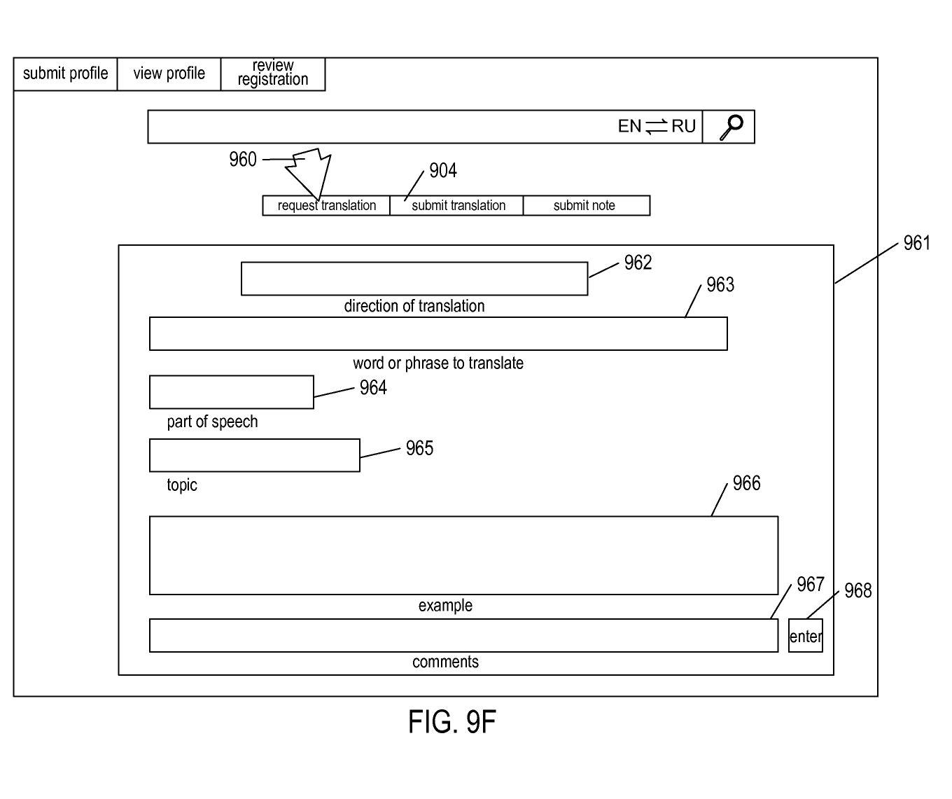

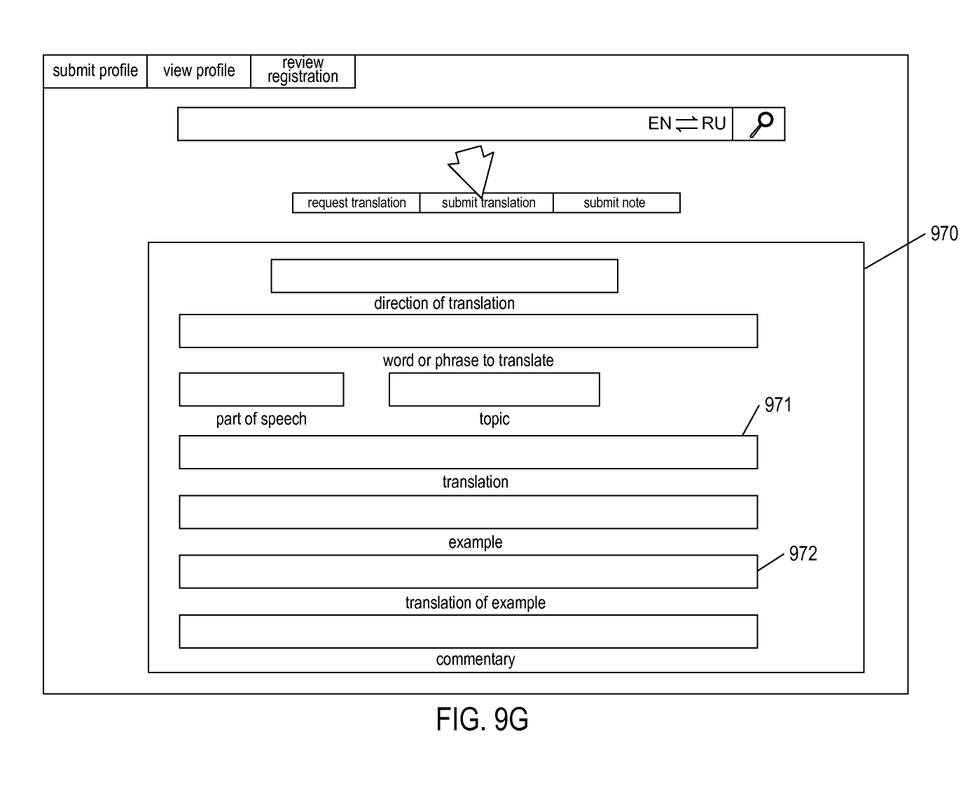

FIGS. 9A-G illustrate a landing page for one implementation of the electronic community-based translation service, displayed by a web browser running on a processed-controlled user device, and numerous features provided by the landing page. The landing page is generally the initial page requested and rendered for display by a user's web browser when the user directs the web browser to access the electronic community-based translation service. Commonly, users input a click to a displayed hyperlink or select a link from displayed bookmarked links in order to direct the web browser to the electronic community-based translation service.

The landing page 900 includes a number of interactive features: (1) a translation-request feature 901; (2) a my-posts feature 902; (3) a community-posts feature 903; (4) a request-translation feature 904; (5) a submit-translation feature 905; (6) a submit-note feature 906; (7) a submit-profile feature 907; (8) a view-profiles feature 908; and (9) a review-registration feature 909. Of course, many different user interfaces are possible, including user interfaces with landing pages that include additional, fewer, and/or different features. The landing page 900 shown in FIG. 9A is one example of the many different possible landing pages and user interfaces that can be implemented as a user interface to the electronic community-based translation service.

In the described implementation, a user may be either an unregistered visitor of the web site or a registered member of the translation-service community. Each registered member is represented, within the electronic community-based translation service, by a user profile that includes various different types of data describing the user, including name, status with respect to one or more languages, level of mastery of one or more languages, a photograph (e.g. a user picture or an avatar), translation-provision history, and many other types of information, in some cases including a photograph. When a user inputs a mouse click to the submit-profile feature 907, the user's profile is provided to the user, in editable format, to allow the user to update and change certain fields of the user's profile. Similarly, input, by the user, of a mouse click to the review-registration feature 909 allows a user to update and edit registration information provided to the electronic community-based translation service. Input of a mouse click, by the user, to the view-profiles feature 908 allows a user to view public portions of other user's profiles. In many implementations, the landing page 900 would additionally provide a login feature to allow a user to log in, as a member, to the electronic community-based translation service. In general, a password and/or other credentials are provided by the user through the login feature. In the currently described implementation, the electronic community-based translation service automatically detects and logs in a user during initial exchanges between the user's web browser and remote servers within the distributed computing system that, in part, implements the electronic community-based translation service.

The my-posts feature 902 provides a logical window through which a user may view any of the posts, or messages, that the user has submitted to the electronic community-based translation service. These posts, as discussed further below, include requests for translation of a word or phrase, responses to requests for translation, unsolicited submission of translations, and notes, or general observations, submitted to the electronic community-based translation service for viewing by the community of users. The community-posts feature 903 provides a logical window into all or a portion of the posts that have been submitted by users of the electronic community-based translation service to members of the community. The my-posts feature 902 and the community-posts feature 903 both operate in similar fashion, next discussed with respect to the community-posts feature 903. Note that, in the case of non-registered visitors, only the community-posts feature is provided on the landing page.

The community-posts feature 903 includes a large display window 911 in which a number of posts are shown. In FIGS. 9A-G, posts are represented by rectangular boxes, such as rectangular box 912. The contents displayed within these boxes is discussed further, below. In general, only a limited number of posts can be viewed at any time within the logical display window 911. Therefore, a scrolling feature 913 is provided to allow the user to scroll the logical window over a much larger number of posts than can be displayed at any given point in time. When the scrolling feature 913 is moved, by user input, towards the extreme portions of its range 914 and 915, an executable that runs within the context of the browser application may automatically fetch additional posts for storage in a local buffer, or cache, so that the scrolling feature can be readjusted to allow scrolling through the newly acquired posts. The community-posts feature 903 additionally includes a filters feature 916 with radio buttons, such as radio button 917, that allows a user to select all or only subsets of the available posts. For example, a user can input a mouse click to the requests radio button 918 to display only request-for-translation posts. The community-posts feature 903 additionally includes a languages feature 920 which displays the languages of the posts, in either translation direction, that a user wishes to view. In other words, selection of languages, using the select feature 921, represents an additional type of filter applied to the posts available from the electronic community-based translation service in order to generate the subset of posts that a user wishes to view in the logical display window 911.

As further discussed below, when a user inputs a mouse click to the request-translation feature 904, an interactive form is displayed that allows a user to prepare and submit a request for translation. When a user inputs a mouse click to the submit-translation feature 905, a form is displayed to allow the user to submit a translation to the community of users. Similarly, when a user inputs a mouse click to the submit-note feature 906, a form is displayed to allow the user to prepare an observation or note on a general topic for display to the members of the electronic community-based translation service. The translation-request feature 901 includes a text-entry portion 922 in which a user can enter, via a keyboard or graphically displayed keypad, a word or phrase that the user wishes to obtain a translation for. Two language-specifying features 923 and 924 allow a user to select, from a pull-down menu, the language of the word or phrase to be translated and the language into which the word or phrase is to be translated. When a user inputs a mouse click to the search-for-translation feature 925, the web browser sends a request to a web server within the distributed computing system for translations available from the electronic community-based translation service.

The landing page thus provides a rich set of input and display features that allow a user to request translations as well as to participate in creating and growing the body of translation information accessible by members of the community of users. In addition, users may communicate with one another by adding comments to request-for-translation posts and unsolicited-translation posts and posting notes.

FIG. 9B shows a request-for-translation post that is displayed in either the my-posts feature (902 in FIG. 9A) or the community-posts feature (903 in FIG. 9A). The request-for-translation post 926 includes an indication 927 of the identity of the user making the request, an indication of the time that the request was made 928, the requested languages and direction of translation 929, in this case from English to Russian, a thumbnail photo or an avatar of the user making the request 930, the word or phrase for which a translation is requested 931, the topic of the usage of the phrase 932, and a review-responses feature 933 that allows a user to view responses posted to the request-for-translation post and an indication of the total number responses. In addition, there is a comment feature 934 where the requesting user, a responder to the request, or any other member of the community can enter a comment and a rating feature 935 that a user viewing the post, other than the requestor, can indicate a positive or negative response to the post and can view the cumulative rating for the post. A rating may be furnished, in certain implementations, as a textual rating, in other implementations as a numerical rating, and in still other implementations as either a textual or numerical rating. In the disclosed implementation, a rating is either an encoded indication of “like” or an encoded indication of “dislike.” The cumulative rating may be displayed as the number of likes and dislikes, a numeric ratio of likes to dislikes, a numeric rating, a number of stars, and other such types of rating indications. Finally, a translate feature 936 allows a different user, viewing the post, to submit a translation for the word or phrase 931.

FIG. 9C shows a response to a request for translation post. The response to the request-for-translation post 937 includes an indication of the name of the responder (translator) 938, a thumbnail photo of the responder or the responder's avatar, an indication of the time of the response 939, the name of the initial requestor 940, the word or phrase for which a translation was requested 941, a translation of the word or phrase 942, an indication of the context in which the word or phrase is used 943, a translation of the context or example 944, an indication of the topic with respect to which the word or phrase is used 945, a ratings feature 946, and a comment feature 947. A similar post, but without information about a requestor, is displayed for an unsolicited translation submission.

FIG. 9D illustrates user input to the language-selection feature (923 in FIG. 9A) that results in a drop-down list of languages 948 from which a user can select the language of a word or phrase that a user wishes to obtain a translation for. FIG. 9E shows a user-initiated search for a translation for a word. As shown in FIG. 9E, the user has selected the Russian language 949 as a language of the word or phrase to translate and has selected the English language 950 for the translation. The user input the Russian word “TOJIKaTb” 951 into the text-entry portion (922 in FIG. 9A) of the translation-request feature (901 in FIG. 9A). Finally, the user input a mouse click, as represented by the cursor 952 superimposed over the translation-request-submit feature 925. In response, a scrollable display window 953 is displayed to the user. The scrollable display window includes the word or phrase to be translated 954, a summary for the user-provided translations 955, and a number of user-provided translation posts, such as post 956, previously submitted by users to the electronic community-based translation service for the word or phrase to be translated 954. The translation posts include translations submitted to request-for-translation posts as well as unsolicited translations submitted to the electronic community-based translation service. The posts are sorted and ordered by ranking, with the highest-ranked posts appearing at the beginning at the display of posts. In the current example, only six posts are displayed but, in general, many more posts may be displayed, viewable by the user via the scrolling feature 957. The summary 955 includes brief alternative translations for each different part of speech that the word can be used as. In the current example, the Russian word “ [symbol] ” is either a transitive verb that means push, shove, poke, or prod, as indicated in the first line 958 of the summary section, or a transitive verb used with the preposition “Ha” with the meaning of incite or put up, as indicated in the second line 959 of the summary section 955.

FIG. 9F illustrates user input to the request-translation feature (904 in FIG. 9A) of the landing page. In response to user input to the request-translation feature 904, as represented by cursor 960 in FIG. 9F, an interactive form 961 is displayed to the user. The form includes text-entry features for the languages and direction of translation 962, the word or phrase to translate 963, the part of speech of the word for which translation is requested 964, the general topic with respect to which the translation is requested 965, an example that uses the word or phrase 966, and comments 967. In general, only a portion of these text-entry fields needs to be filled in by the user in order to request a translation. For example, in certain implementations, it is sufficient for the user to indicate the languages and direction of translation and the word or phrase for which the translation is requested. When the user input a mouse click to the submit feature 968, an executable running in the context of the browser packages the information input to the interactive form into a translation-request message that is posted to a web server within the distributed computing system portion of the electronic community-based translation service. As further discussed below, when the request meets several threshold requirements, the request for a translation appears as request-for-translation post, as shown in FIG. 9B, in the community-posts feature (903 in FIG. 9A) of those members of the translation-service community currently accessing the electronic community-based translation service.

FIG. 9G illustrates, using similar illustration conventions as used in FIG. 9F, the interactive form displayed to a user upon user input to the submit-translation feature (905 in FIG. 9A) of the landing page. This feature, as discussed above, allows a user to submit an unsolicited translation to the electronic community-based translation service. The interactive form 970 includes many of the same fields included in the interactive form (961 in FIG. 9F) displayed for preparation of a request-for-translation post. Additional fields include a field for the submitted translation 971 and for translation of an example or context 972.

The user interface provided as a web site to users of the electronic community-based translation service, in many implementations, may include many additional pages and features to provide many additional functionalities. For example, features may be provided to allow users to reply or respond directly to posts, with the responses or replies appended to the contents of the displayed post for all community members to observe. As another example, many implementations of the electronic community-based translation service involve human moderators or administrators to which users can direct comments or posts. As one example, were a user to view an inappropriate, nonsensical, or profane post in the user's community-post display feature, the user may flag the post for moderator or administrator intervention. Additional facilities may allow users who have submitted a post to subsequently edit, change, retract, or delete the post. In certain implementations, users may initiate semi-private chat or message exchanges with other users.

### An Implementation of the Electronic Community-Based Translation Service

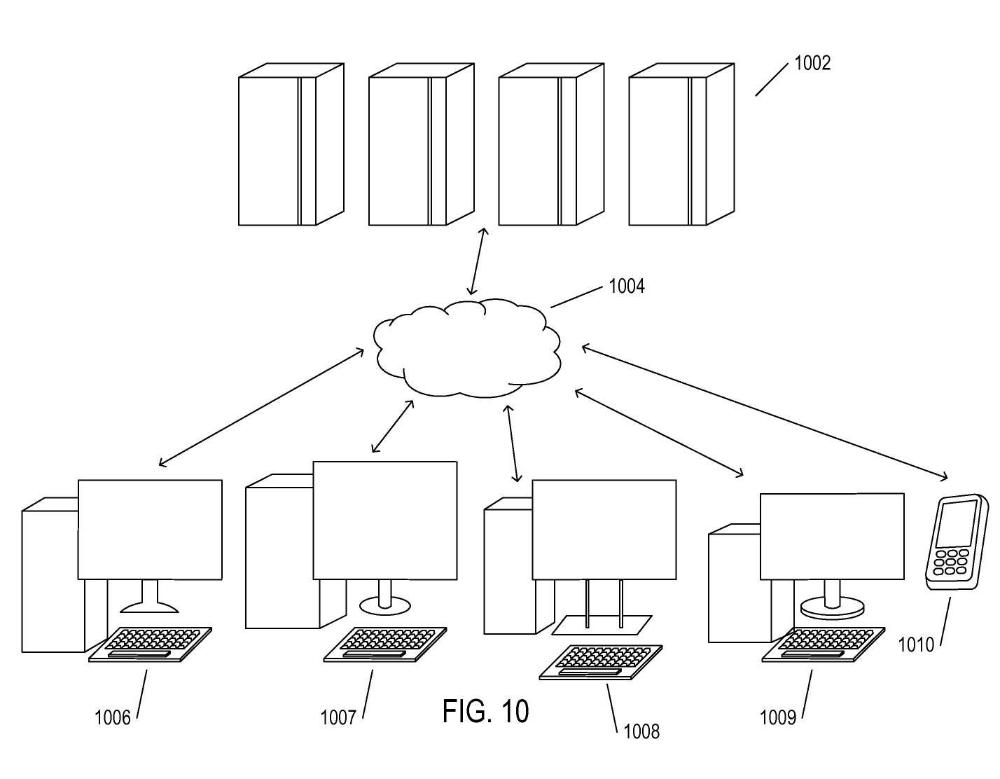

FIG. 10 illustrates the overall hardware-level and communications-infrastructure-level architecture of one implementation of the electronic community-based translation service. The electronic community-based translation service includes a distributed computer system 1002 that includes a number of web servers that serve web pages of the electronic-community-based translation-service web site, including the landing page discussed above with reference to FIGS. 9A-G, as well as a variety of application servers that carry out requested services on behalf of users or members of the electronic community-based translation service. In addition, the distributed computing system 1002 generally includes various internal data-storage devices and external data-storage appliances. In many implementations, the distributed computer system 1002 may be not only distributed across multiple discrete computers, but may be geographically distributed across multiple geographically dispersed cloud-computing facilities. In general, the distributed computer system is referred to as a “data center.” In certain implementations, the data center may include only a single server computer. The distributed computing system 1002 is interconnected, via the Internet 1004, to many different processor-controlled user devices 1006-1010. These devices may include desktop computers, work stations, laptop computers, notebooks, smartphones, and other such processor-controlled user devices. In the currently described implementation, the processor-controlled user devices each runs a web browser that allows a user to view and interact with the electronic-community-based translation-service web site. Many implementations may support concurrent and simultaneous access of the electronic community-based translation service by thousands, tens of thousands, or more users.

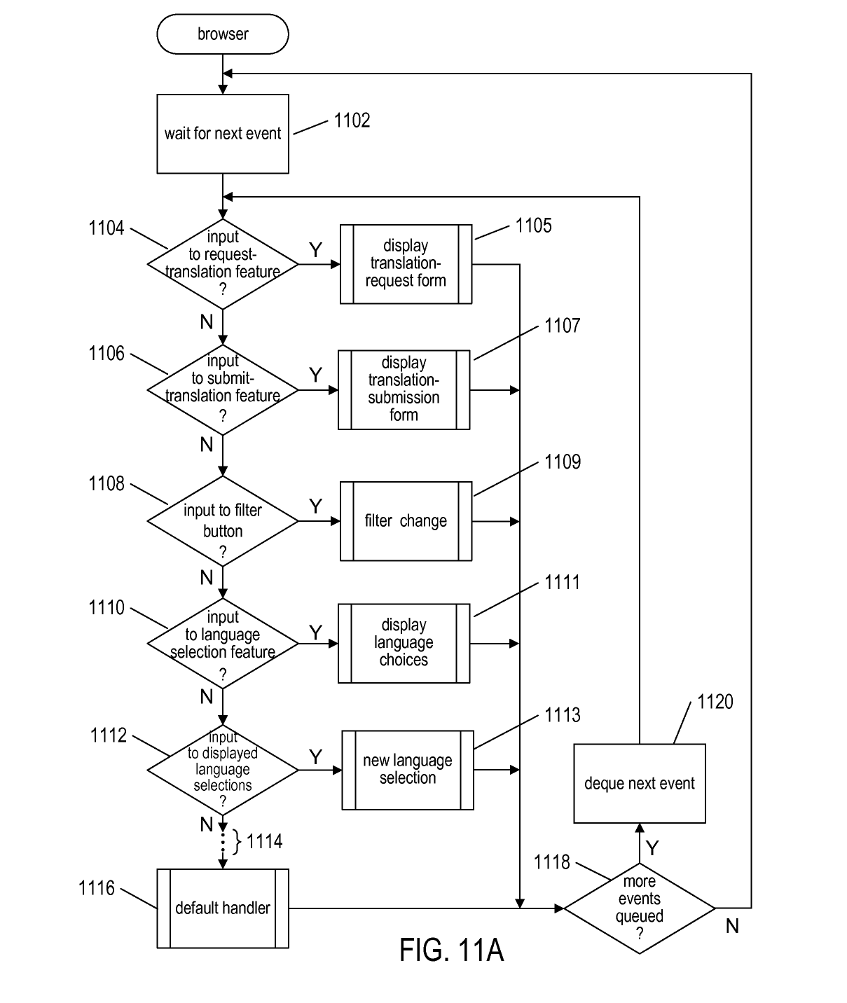

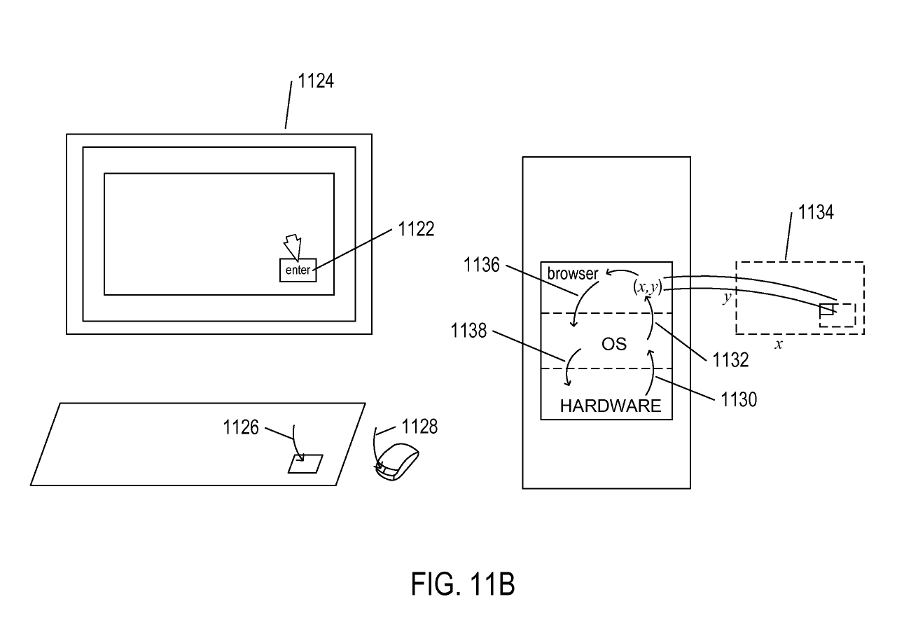

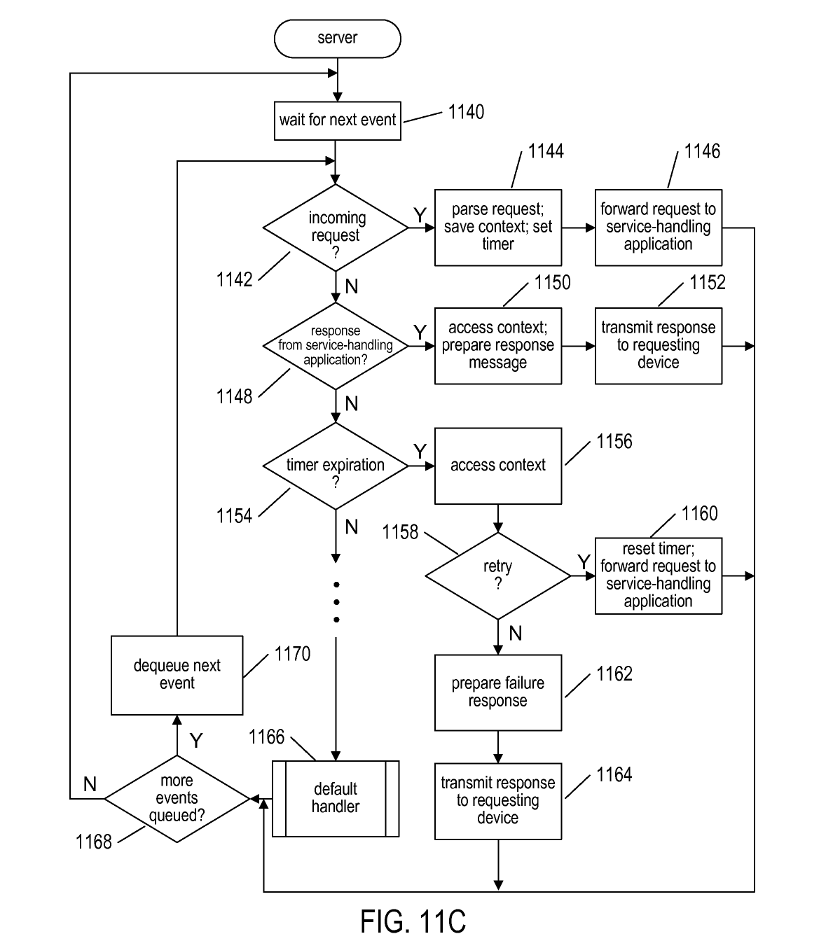

FIGS. 11A-C illustrate the general implementation of the control subsystems within the electronic community-based translation service. FIG. 11A provides a control-flow diagram for a browser application that runs on a processor-controlled user device to implement the interactive user interface through which a user requests and receives translations and posts translations and notes to the electronic-community-based-translation-service user community. The browser application operates in a continuous loop in which, at step 1102, the browser waits for a next event to occur and then responds to the event. Many different types of events are handled by the browser control logic, including user-input events provided to the browser application by the operating system running on the processor-controlled user device, timer expirations, the arrival of response messages from the distributed computing system that includes web servers that serve the web pages of the electronic-community-based translation-service web site, also provided to the browser application through the operating system, and many additional types of events. When an event occurs, the application-browser control logic determines the identity of the event that occurred and then handles the events, generally through a call to an event handler. For example, in step 1104, when the event represents input to the request-translation feature, as determined in step 1104, the browser application calls a display-translation-request-form executable 1105 to display the translation request form to solicit translation-request information from the user, as discussed above with reference to FIG. 9F. Similarly, when the event is user input to the submit-translation feature, as determined in step 1106, then the browser control logic invokes a display-translation-submission-form routine, in step 1107, to display the translation-submission form, discussed above with reference to FIG. 9G. When the event is user input to a filter radio button, as determined in step 1108, the browser, in step 1109, invokes a filter-change routine to change the displayed, selected filter type and, in certain cases, to undertake display of posts and retrieve new posts that meet the new filter constraints. When the event is user input to a language-selection feature, as determined in step 1110, the browser, in step 1111, invokes a routine to display the various choices of languages in a drop-down language-display window, as discussed above with reference to FIG. 9D. When the next event is input to the displayed language selections, as determined in step 1112, a new-language-selection is called, in step 1113, to add the selected language to the lists of selected languages and, in certain cases, to undertake display of posts and retrieve new posts that meet the new filter constraints. As indicated by ellipses 1114 in FIG. 11A, many other events are handled by the browser application. For example, in certain implementations, the browser may run an executable that continuously sets timers, at the expiration of which new posts are solicited from a web browser to display in the my-post and community-post features, following which the timer is reset. In this fashion, the browser continuously polls for new posts to display to the user. In other implementations, by contrast, the distributed computer system pushes new posts out to connected user devices, with incoming-post events generated for handling in the control loop. Any events that are not explicitly tested for and handled are handled by a default handler 1116. Following handling of the event that triggered event handling in step 1102, the browser logic determines whether or not there are more events that have been queued while the previous event was handled, in step 1118. If so, then, in step 1120, a next event is dequeued from an event queue and control flows back to step 1104. Otherwise, control flows back to step 1102, where the browser waits for a next event to occur.

FIG. 11B illustrates how events are generated and provided to step 1102 of FIG. 11A by a processor-controlled user device. As shown in FIG. 11B, a user has manipulated a cursor over an “enter” feature 1122 of a display device 1124 The user then inputs a mechanical input to a keyboard key 1126 or a mouse key 1128 to indicate that the user wishes to enter some information to the browser application which, in general, will be transferred to the distributed computer system that includes web servers that serve web pages of the electronic-community-based translation-service web site. The key click or mouse click is initially detected by keyboard or mouse controllers and transmitted, as an interrupt, to the operating system executing on the processor-controlled user device, as represented by arrow 1130. The operating system then processes the input and determines that the keyboard click or mouse click is to be handled by the browser application, and transmits the mouse click to the browser application, as represented by arrow 1132, as an application interrupt or by another mechanism. The browser receives, from the operating system, the display-screen x,y coordinates for the mouse click which the browser application then interprets, using a two-dimensional feature map 1134, to determine to which feature the mouse click or keyboard click was input. The browser then implicitly or explicitly generates a feature-click event handled by the control loop discussed above with reference to FIG. 11A. In general, after taking action to handle the event, the browser makes one or more calls to the operating system, represented by arrow 1136 which, in turn, involves numerous control inputs to the hardware layer 1138. For example, when the mouse click results in transmitting a completed translation request to the distributed computing system, the browser application prepares a message and invokes operating system networking functionality to transmit the message to the distributed computing system. This involves control inputs, by the operating system, to communications-device controllers, generally through controller registers mapped to memory locations accessible to the operating system.

FIG. 11C provides a control-flow diagram for the control logic of a web server within the distributed computing system. Like the browser application, the web server generally functions as an endless loop, in the first step of which 1140 the server waits for a next event and, when a next event occurs, processes the event. When the next event is an incoming request, as determined in step 1142, the web server receives, in step 1144, the request from the operating system executing within the web server, parses the request, saves a context to identify the type of request and a remote communications address of the requestor, and sets a timer to ensure that, should the request not be properly handled by an application server, the web server can either retry the request or return an error message to the requestor. Then, in step 1146, the web server forwards the request to a service-handling application running within an application server in the distributed computing system. When the event is a response received from a service-handling application, as determined in step 1148, the web server, in step 1150, accesses the context previously stored for the request that was forwarded to the service-handling application and uses information within the context to prepare and properly address a response message to the requestor. In step 1152, the response message is transmitted to the requesting processor-controlled user device. When the event is a timer expiration, as determined in step 1154, then, in step 1156, the server accesses the context associated with a request that is, in turn, associated with a timer. The contexts may store an indication of how many times a request for processing has been attempted for the request. When the number of times a request for processing has been attempted is less than a threshold value, as determined in step 1158, then, in step 1160, the server resets the timer and forwards the request to the service-handling application. Otherwise, the web server prepares a failure response, in step 1162, and transmits the response to the requesting user device in step 1164. As in the case of the browser application control logic, discussed above with reference to FIG. 11A, a default handler 1166 handles any types of events that are not explicitly handled by web server logic that includes a detection step and event handling steps, as, for example, detection step 1142 and incoming-request handling steps 1144 and 1146. When there are more events that have occurred than have been queued since the previously handled event initiated processing, as determined in step 1168, then a next event is dequeued from an event queue, in step 1170, and control returns to step 1142. Otherwise, control returns to step 1140.

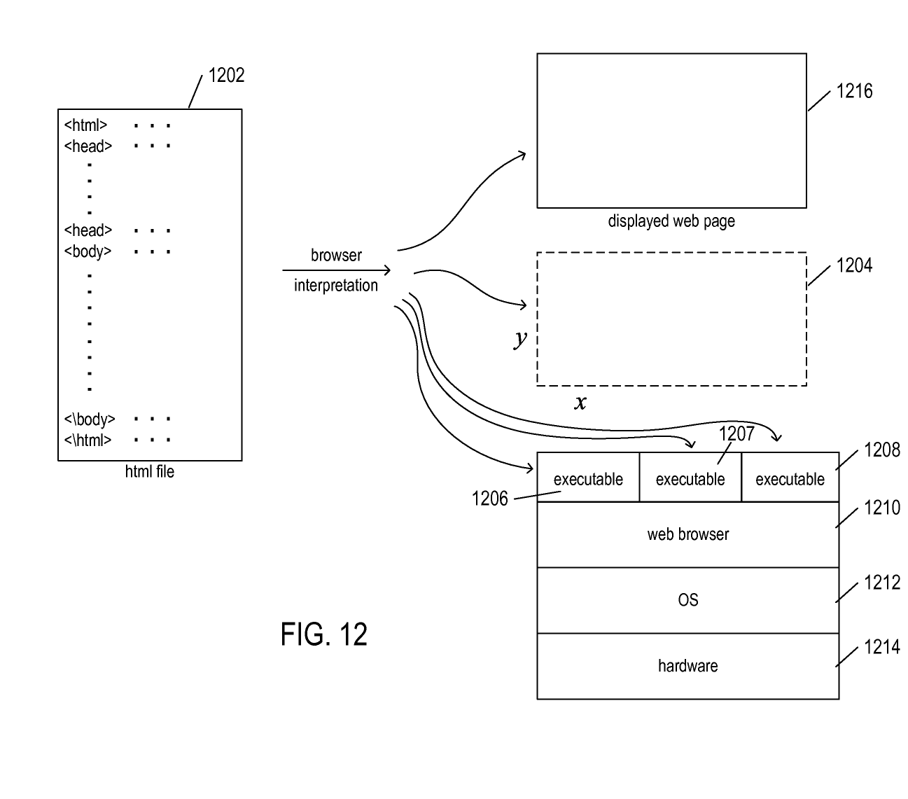

FIG. 12 illustrates how the browser application on a processor-controlled user device is controlled by the electronic community-based translation service to provide the interactive user interface by which users post requests for translations, translations, and general messages to the community of electronic-community-based translation-service users. In general, the browser is directed, by user input to hyperlinks or menu selections from bookmarked menus, to download a hypertext markup language (“HTML”) file from a web server of the distributed computing system. The HTML file 1202 is a formatted file that contains HTML tags and tag bodies that contain a variety of statements. The browser application, upon receiving the HTML file, begins to interpret the HTML statements contained in the file. Interpretation of the HTML file provides the browser application with a map 1204 of the display screen that includes the dimensions, colors, and other parameters of all the features of the displayed web page. In addition, HTML instructions embedded within the HTML file direct the browser application to request additional files and information from the web server and other sources, including images, executables, audio files, and other such information. The executables 1206-1208 operate in an execution environment provided by the web browser 1210 which, in turn, executes within an execution environment provided by the operating system 1212 and hardware 1214 of the processor-controlled user device. All of the requested information and the instructions contained in the HTML file 1202 are combined by the browser application to produce a rendered web page 1216 that is displayed on a display device of the processor-controlled user device. Thus, the HTML file that is requested by the browser application and furnished to the browser application by a web server of the distributed computer system, along with additional scripts, executables, images, audio files, and other such information that the browser application is directed to acquire from the web server and other information sources by statements in the HTML file, provide the control logic and data that together implement the interactive user interface through which users access the electronic community-based translation service.

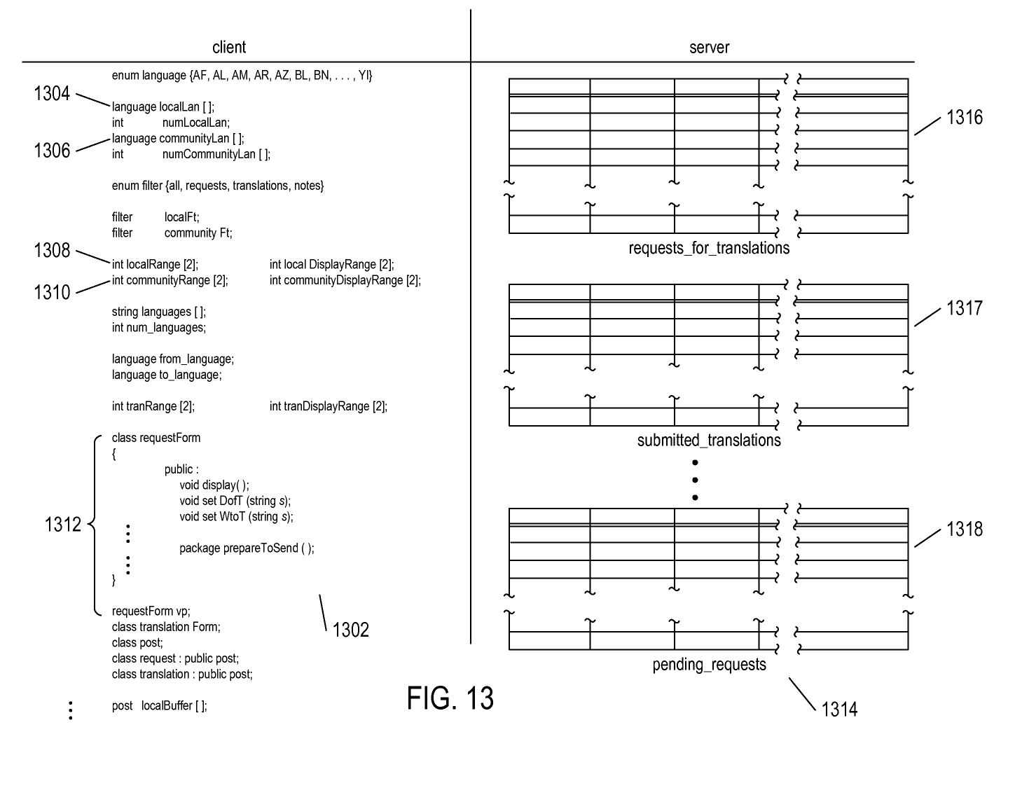

FIG. 13 illustrates the data component of the client and server portions of the electronic community-based translation service. In addition to scripts, executables, and information rendered to display provided to the browser application by the HTML file and additional information sources, discussed above with reference to FIG. 12, the browser application also maintains data within memory accessible to the browser application provided as one component of the execution environment by the operating system. In the right-hand portion of FIG. 13 1302, C or C++-like pseudocode is used to indicate various different types of data that may be stored by the browser application to implement the interactive user interface. The browser may store a list of languages that can be selected for the my-posts feature 1304 and a list of languages that can be selected for the community-posts feature 1306. The browser may store, as another example, a range of post IDs currently being displayed to a user for the my-posts feature 1308 and the community-posts feature 1310. As yet another example, the browser may store an instance of a class 1312 that implements the translation-request form. As indicated on the right-hand side of FIG. 13 1314, the distributed computing system may store a variety of different types of data in relational-database tables 1316-1318. For example, one table may store the requests for translations 1316 that have been received, accepted, and made available for viewing by users of the electronic community-based translation service. Each row in the request-for-translations table 1316 includes the data that represents each request for translation. In alternative implementations, various different types of data and data-storage methodologies may be employed both by the browser applications of the processor-controlled user devices and by the web servers, application servers, and other computational components of the distributed computing system.

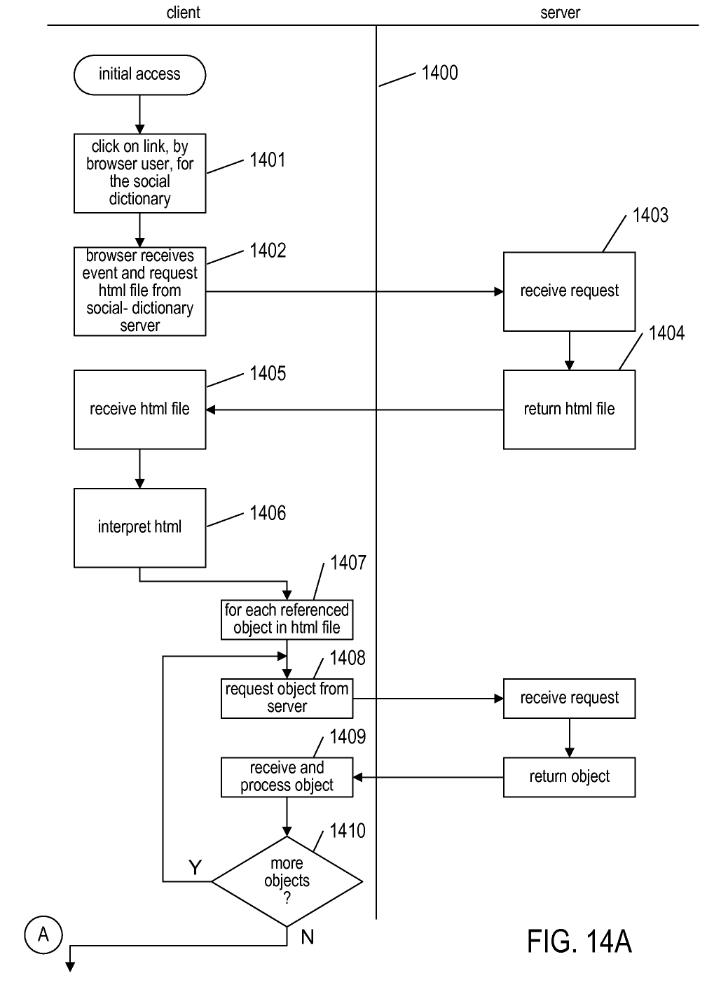

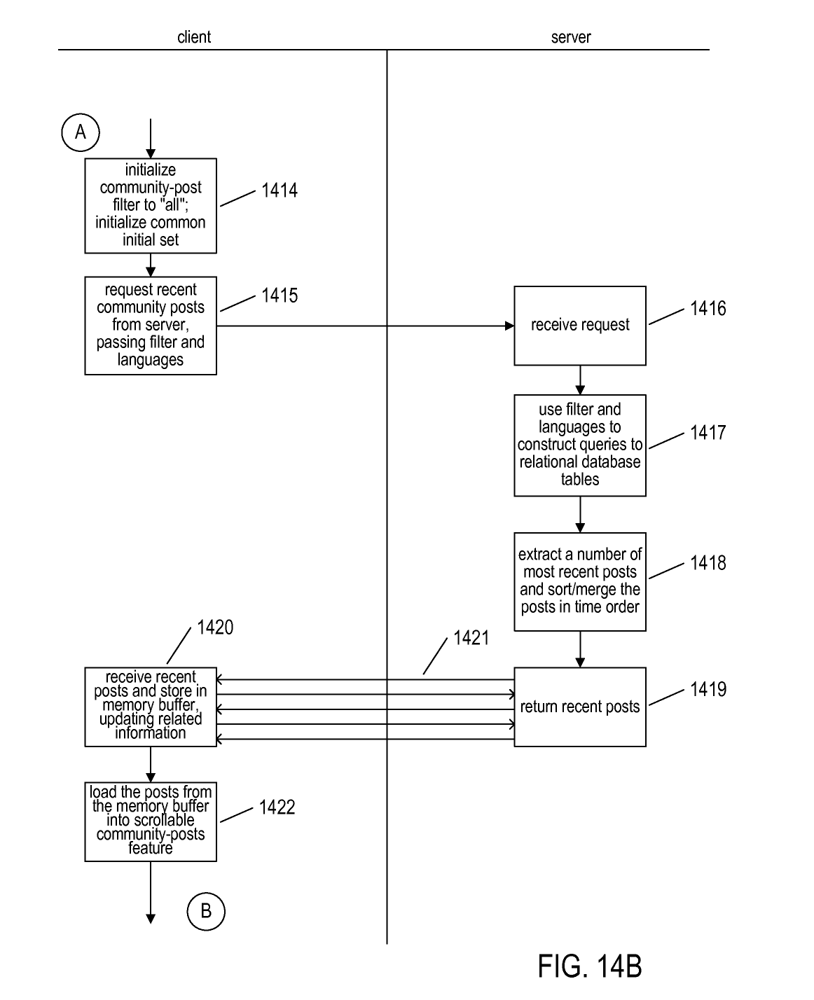

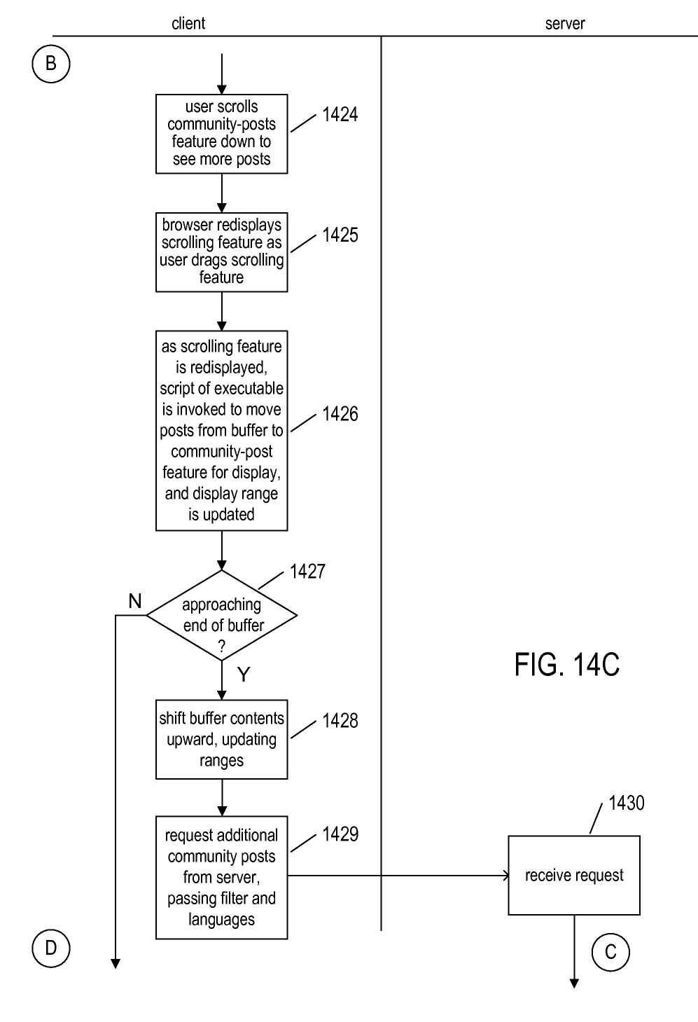

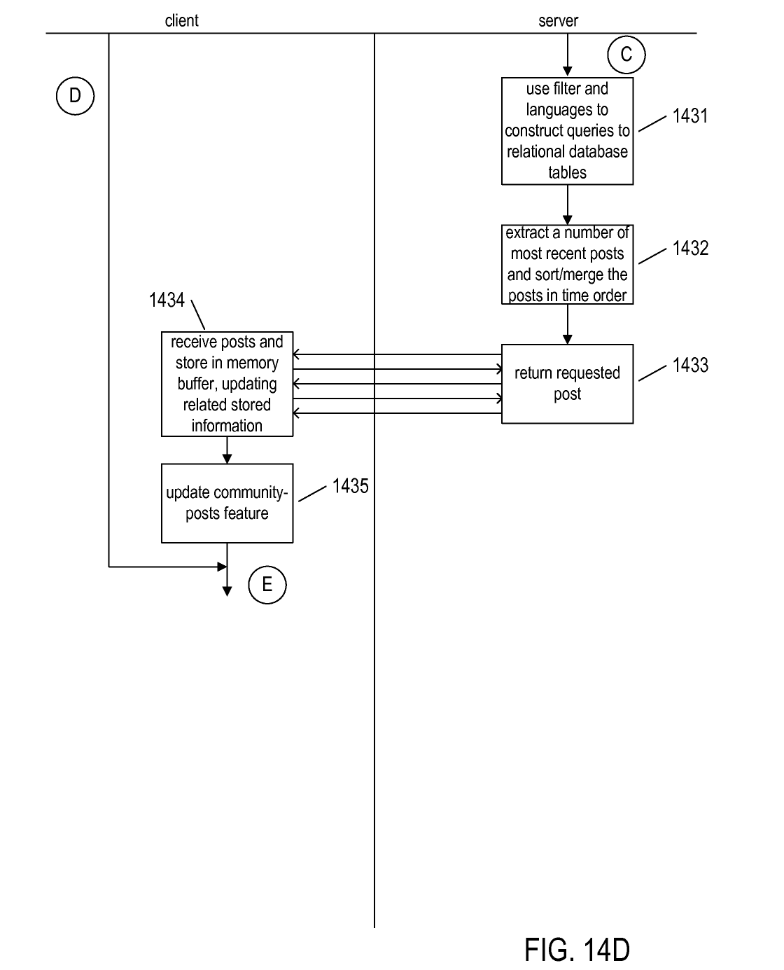

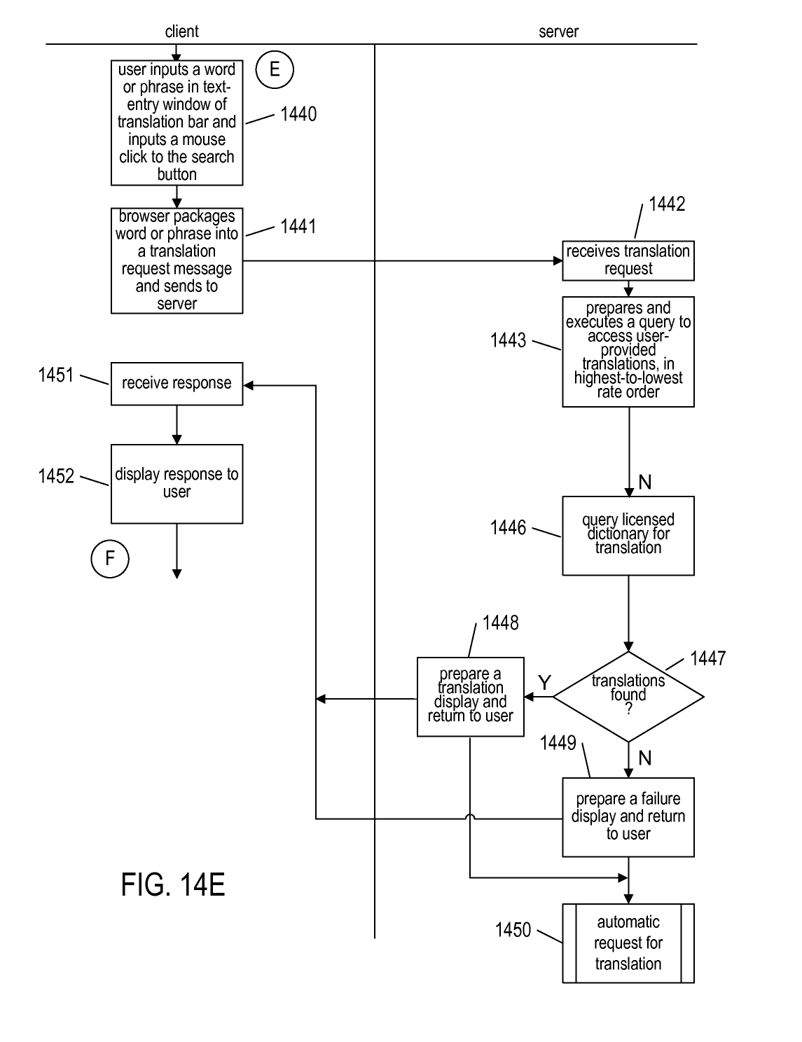

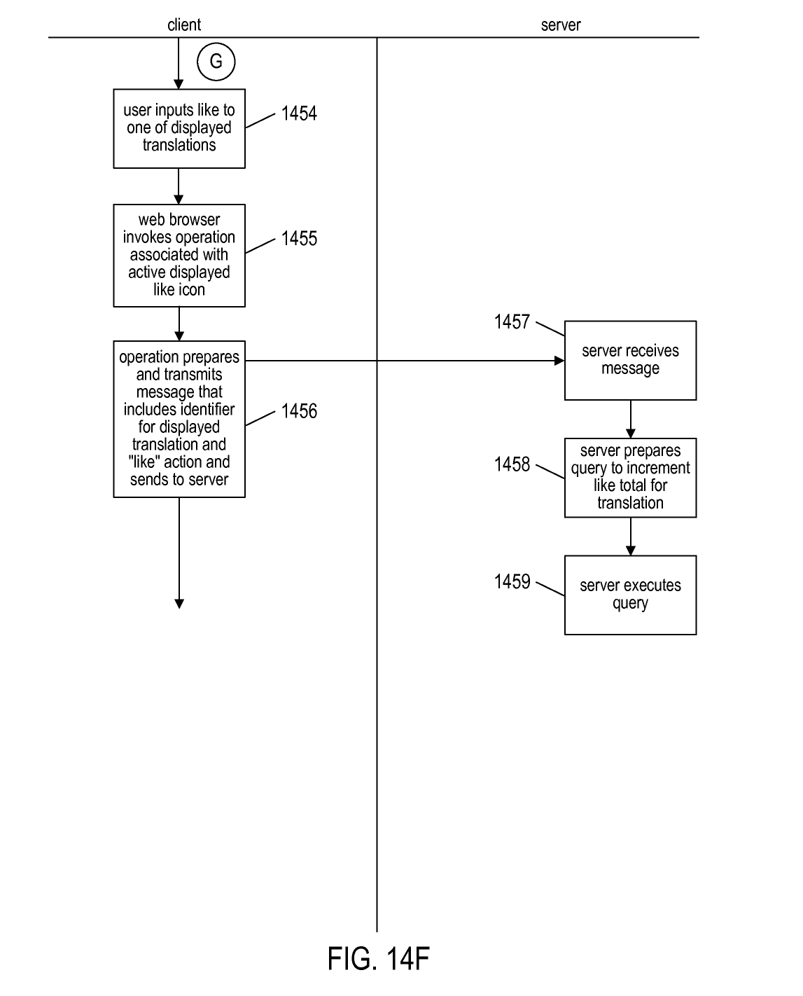

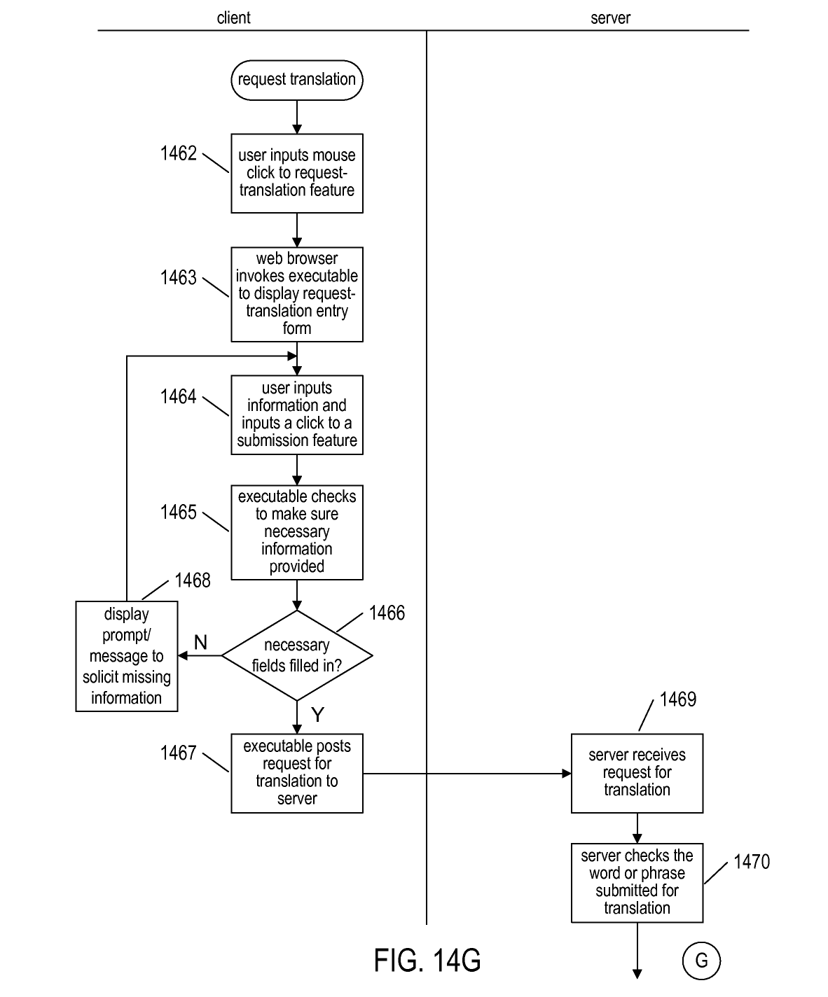

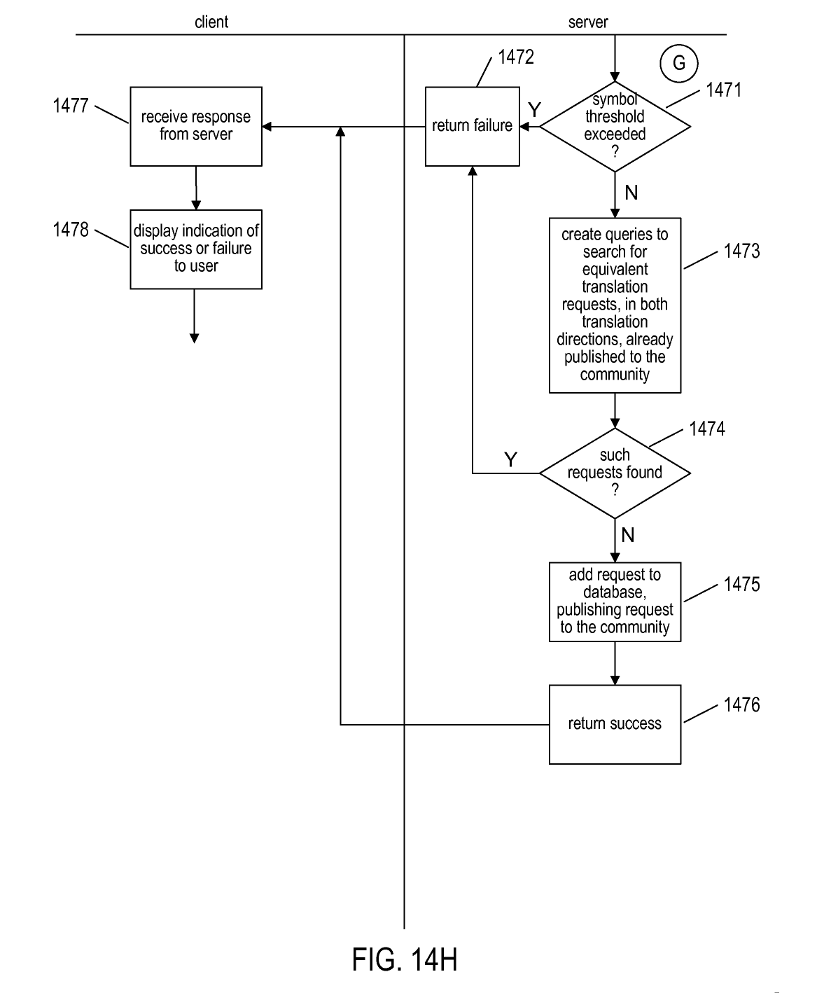

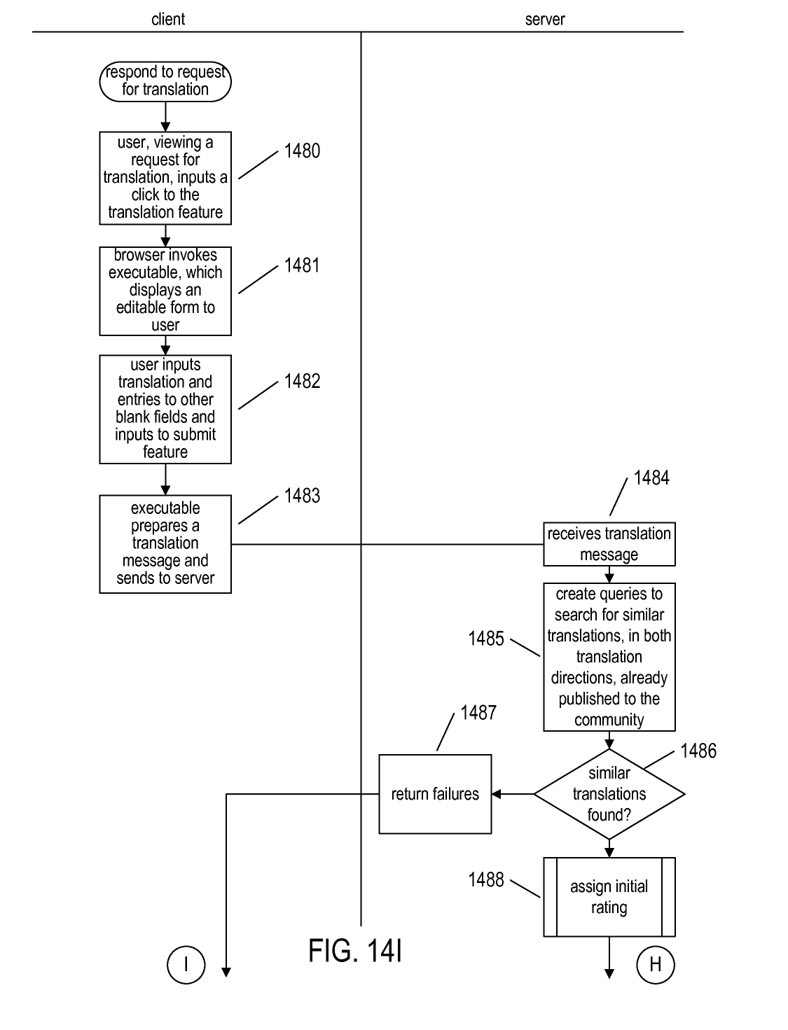

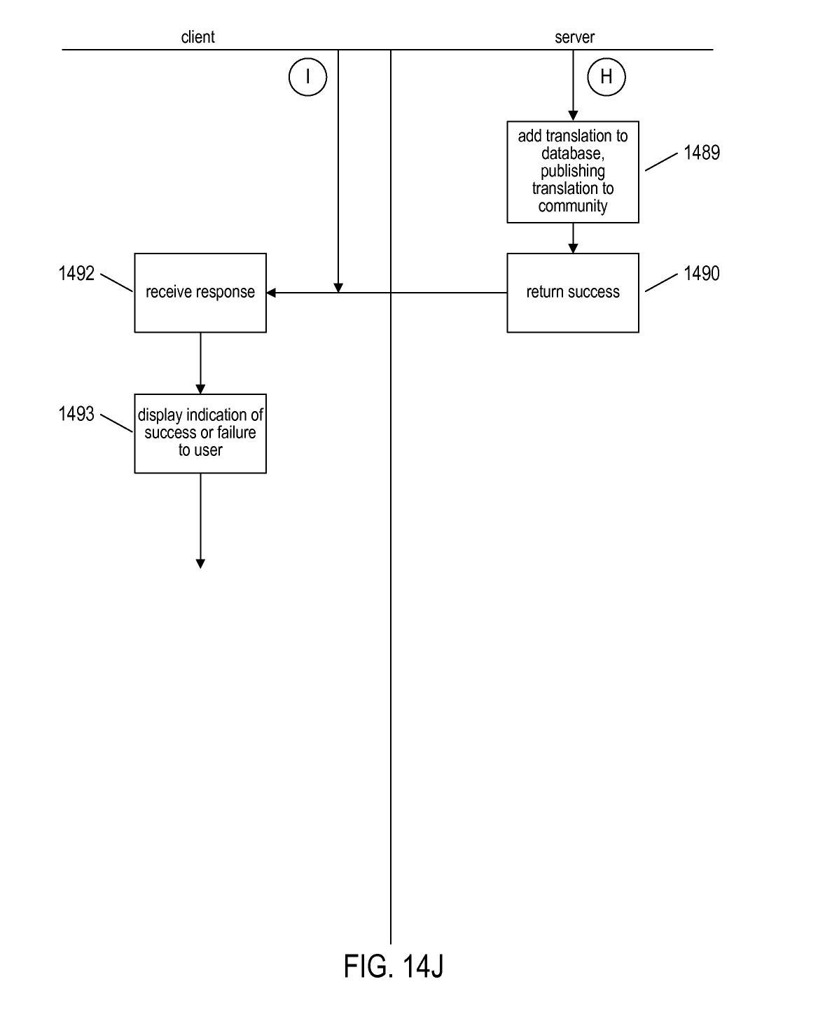

FIGS. 14A-J illustrate, using control-flow diagrams, one implementation of the electronic community-based translation service to which the current document is directed. FIGS. 14A-J illustrate access, by a user, of the interactive user interface provided by the electronic community-based translation service and numerous requests made by the user through the interactive user interface. These figures are intended to show higher-level control and logic and assume underlying application-browser and web-server implementations, such as those discussed with reference to FIGS. 11A-C, above, as well as an underlying computational and communications infrastructure, such as those described in the preceding subsection. The example begins with a user already interacting with an interface displayed to the user by the browser application running on a processor-controlled user device. Each of FIGS. 14A-J are divided into two portions by a vertical line 1400. The left portion illustrates client-side actions and the right portion illustrates web-server-side actions. It is also assumed that actions carried out on the server side may include actions carried out by web servers, application servers, data-storage systems, and other discrete computational entities that together comprise the distributed computing system.

In step 1401, the user clicks on a link displayed by the browser application that directs the browser application to the electronic community-based translation service, referred to as the “social dictionary” in FIGS. 14A-J. In step 1402, the browser application receives the click event and, in response, requests the HTML file for the landing page of the social dictionary from a social-dictionary server. In step 1403, the server receives the request and, in step 1404, returns the requested HTML file to the client-side browser application. In step 1405, the browser application receives the HTML file, via operating system networking functionality, and, in step 1406, begins to interpret the HTML file. In the for-loop of steps 1407-1410, as the browser application interprets the HTML file, the browser application requests each object referenced in the HTML file and receives the requested object from the server. As mentioned above, the referenced objects may include scripts, executables, and images and other information that can be rendered for display to the user by the browser application. In certain cases, the objects may be requested from servers other than the social-dictionary server to which the original HTML-file request was directed in step 1402.

Continuing with FIG. 14B, once all of the referenced objects have been received by the browser application, the browser application begins to render and display the interactive user interface to the user. As part of this rendering and displaying of the interactive user interface, the browser application, in step 1414, initializes the filter and language selection for the community-post feature (903 in FIG. 9A) and requests, from the server, the most recent community posts that pass the current filter and language selections associated with the community-post feature, in step 1415. The server receives the request, in step 1416, uses the filter and language selections to construct one or more relational-database queries, in the described implementation, in step 1417, and uses the queries to extract the values for all of the fields for the most recent posts stored by the server in the database, in step 1418. When multiple queries are executed, such as the case for a non-restrictive filter that directs the server to extract general notes, requests for translation, and provided translations, the posts are merged and sorted in time order by the server. In certain implementations, as part of the request submitted to the server in step 1415, the browser application may provide an indication to the server of some total maximum number of text symbols that can be accommodated by the application browser on the display device associated with the user's processor-controlled device. In other cases, the number of posts returned may be a parameter specified either by the user's browser application or encoded in server logic. In still other implementations, the application browser may continue to request posts up until the point that the display buffer is filled on the client side. In the currently discussed implementation, once the server has prepared a set of time-ordered posts, the server begins to return the posts in step 1419. In step 1420, the application browser receives the posts and stores the posts in a memory buffer for the community-post feature, updating related information such as the range of posts, number of posts, and other such information used by the application browser for displaying and scrolling the display portion of the community-post feature. Multiple arrows 1421 are shown between steps 1419 and 1420 to indicate that, in certain implementations, there may be multiple requests/response transactions involved in transferring posts from the server to the application browser. Finally, in step 1422, the application browser loads posts received from the server and stored in the memory buffer into the scrollable community-posts display for display to the user.

The currently described user interaction examples continue with FIG. 14C. In step 1424, the user manipulates the mouse to scroll the community-posts display area downward to view more posts. In response, in step 1425, the browser redisplays the display area of the community-posts feature to show a different set of posts, updating, as well, the location of the position indicator within the scrolling feature. As scrolling proceeds, in step 1426, the application browser continues to move posts into the display area from the buffer and update indications of the display range. When scrolling operations result in the application browser approaching the end of the buffer, as determined in step 1427, the application browser shifts the post within the buffer upward, updating the indications of the stored range of posts, freeing up more space within the buffer for additional posts in step 1428. Then, in step 1429, the application browser requests additional community posts from the server, again passing the current filter and language-selection parameters as well as, in certain implementations, an indication of the number of text symbols that can be additionally accommodated in the memory buffer. The server receives the request, in step 1430, and then, turning to FIG. 14D, carries out the requests in steps 1431-1433 similar to steps 1417-1419 discussed above with reference to FIG. 14B. The application browser receives the posts, in step 1434, storing the new posts in the freed-up area of the memory buffer and updates the display of the community-posts feature in step 1435.

The examples of user interaction continue with FIG. 14E. In step 1440, the user next inputs a word or phrase into the text-entry portion of the translation-request feature and inputs a mouse click to the search button of the translation-request feature. In step 1441, the browser application packages the word or phrase input by the user into a translation-request message and sends the translation-request message to the server. In step 1442, the server receives the translation request and, in step 1443, prepares a query to access user-provided, community translations stored in one or more of the database tables. The query includes query language to select translations in highest-to-lowest order by the ratings associated with the translations. In this way, the highest-rated translations are first returned to the user device for display to the user. The server also queries one or more licensed commercial dictionaries to obtain one or more dictionary translations, in step 1446. When one or more commercial-library translations and/or community translations are found, as determined in step 1447, the server prepares a display of the translations and returns the display information to the application browser for display to the user, in step 1448. In the described implementation, the dictionary translations are first included in the display along with, or followed by, a summary of the community translations, as discussed above with reference to FIG. 9E, and appends the initial translations to the summary, followed by all or a portion of the full community translations. Otherwise, in step 1449, the server prepares a failure display or failure message and returns the failure message to the application browser. When user-provided translations are not identified as a result of the query execution in step 1443, the server also issues an automatic request for translation that is posted to users of the electronic community-based translation service, in step 1450. In step 1451, the application browser receives the response from the server and, in step 1452, displays the response. When the response contains a summary and a set of user-provided translations, the information is displayed as discussed above with reference to FIG. 9E.

The example user interactions continue with FIG. 14F. In step 1454, the user inputs a “like” rating to one of the displayed user-provided translations. In step 1455, the browser application invokes a script or executable associated with the active displayed “like” icon within the displayed translation. In step 1456, the script or executable prepares and transmits a message that includes an identifier for the displayed translation and an indication that the user wishes to add a “like” rating to the user-provided translation. In step 1457, the server receives the message from the application browser, prepares a query to increment the total of “like” ratings for the translation, in step 1458, and then executes the query, in step 1459, in order to increase the number of “like” ratings associated with the translation.

FIGS. 14G-H illustrate a user request for a translation via the request-translation feature (904 in FIG. 9A). In step 1462, the user inputs a mouse click to the request-translation feature. In step 1463, the browser application invokes a script or executable associated with the request-translation feature that displays the request-translation form, discussed above with reference to FIG. 9F, in order to solicit user input of the information needed to post a translation request to the user community. In step 1464, the user inputs information to various fields within the request-translation form and clicks a submission feature. In step 1465, the script or executable checks to make sure that the necessary information has been provided. For example, in certain implementations, in order to post a request for translation, a user needs to at least provide the direction of translation and a word or phrase that the user wishes to be translated. In other implementations, additional fields may be required for the translation request to be posted to the users. When the necessary fields have been filled in by the user, as determined in step 1466, the script or executable posts a request for translation to the server, in step 1467. Otherwise, in step 1468, the script or executable may display a prompt or message to solicit user input of the missing or needed information. In step 1469, the server receives the request for translation. In step 1470, the server checks the word or phrase that the user wishes to be translated. When a symbol threshold is exceeded, as determined in step 1471, a failure message is returned by the server to the application browser in step 1472. In the discussed implementation, translation of only single words or short phrases are supported. In other implementations, the symbol threshold may be longer or there may not be a symbol threshold. Next, in step 1473, when the symbol threshold has not been exceeded, the server creates one or more queries to search for equivalent translation requests, in either direction, that have already been published to the community. When such requests are found, as determined in step 1474, the server may return a failure message to the user to indicate that the request-for-translation post cannot be posted since translations for the word or phrase already exist. In certain implementations, this failure may be accompanied by some number of the highest-rated translations already posted by users as discussed above with reference to FIG. 14E. Otherwise, in step 1475, the request is added to the database, which effectively publishes the request to the user community. Users currently interacting with the electronic community-based translation service quickly receive displays of the post in the display area of their community-post feature. Then, in step 1476, a success message is returned to the application browser. In step 1477, the application browser receives a response from the server and, in step 1478, displays an indication of success or failure for the user's attempt to post the request for translation. In certain implementations, when translations for the word or phrase already exist, those may be returned by the server and displayed to the user in step 1478.

FIG. 14I-J illustrate a user responding to a posted requested for translation. In step 1480, the user, while viewing a request for translation, inputs a click to the translation feature (936 in FIG. 9B). In step 1481, the browser application invokes a script or executable which displays an editable form to the user to solicit the translation, similar to the form discussed above with reference to FIG. 9G. This form may include information already provided by the user who requested the translation which is not editable by the user responding to the request for translation. In step 1482, the user inputs the translation and information to other blank fields of the form. In step 1483, a script or executable prepares a translation message, including an identifier for the request-for-translation post to which the user is responding, and sends the translation message to the server. In step 1484, the server receives the translation message. In step 1485, the server prepares queries and executes the queries to search for similar translations, in both directions, that may have already been published to the community. When similar translations are found, as determined in step 1486, the server returns a failure message to the application browser in step 1487. Otherwise, in step 1488, the server assigns an initial rating for the translation and then, in step 1489, adds the translation contained in the received message to the database, effectively publishing the translation to the community. The server then returns a success message in step 1490. In step 1492, the application browser receives the response and, in step 1493, displays an indication of success or failure of posting of the translation to the community.

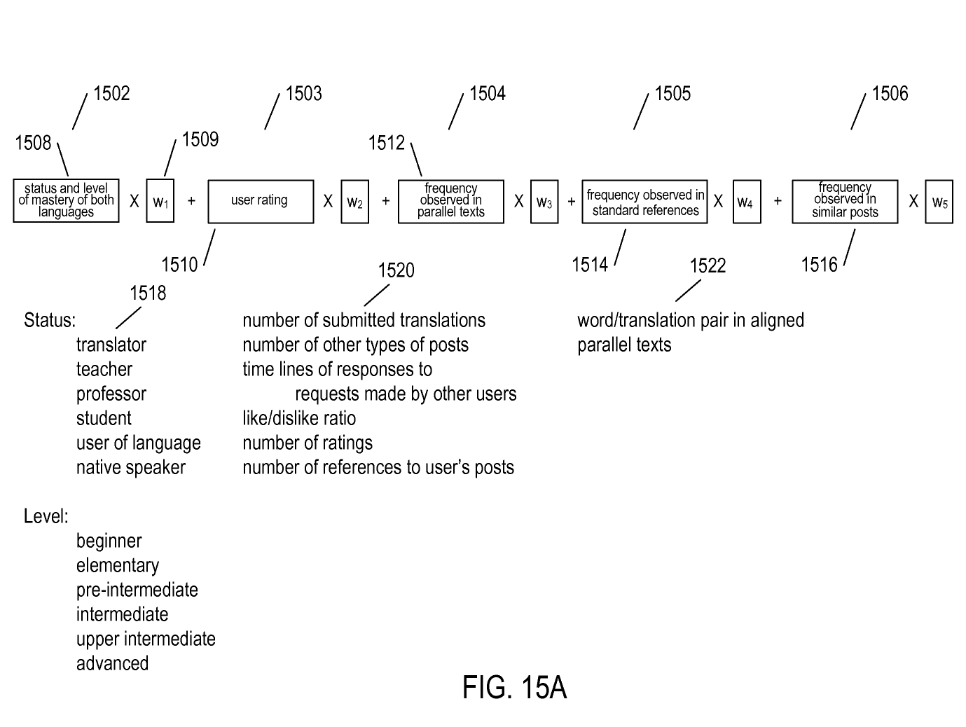

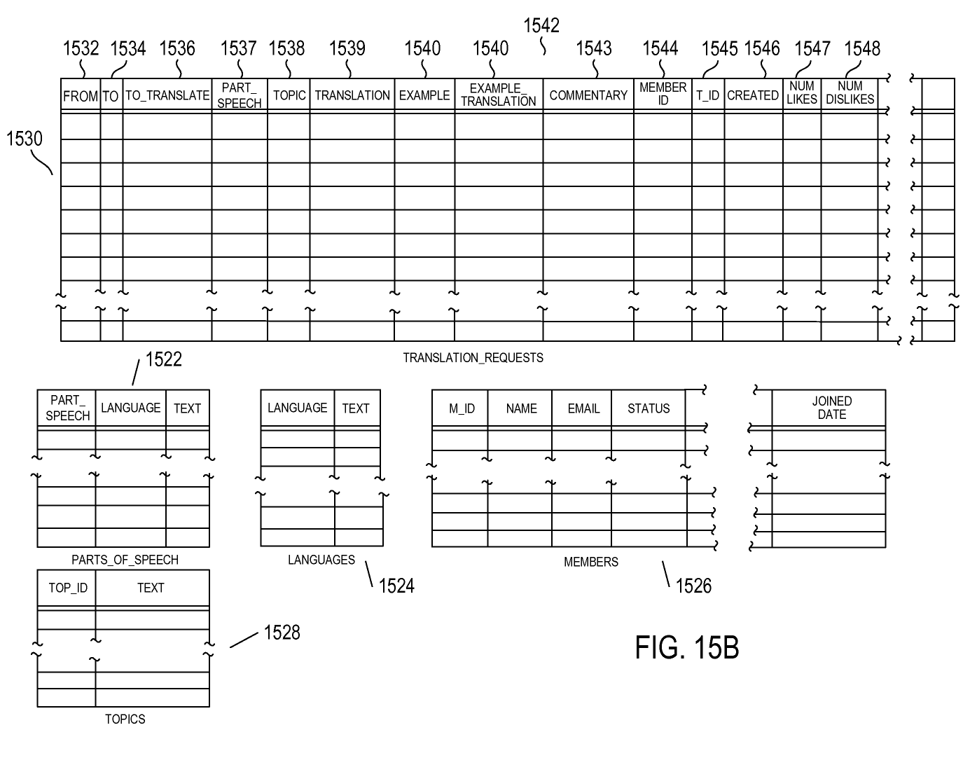

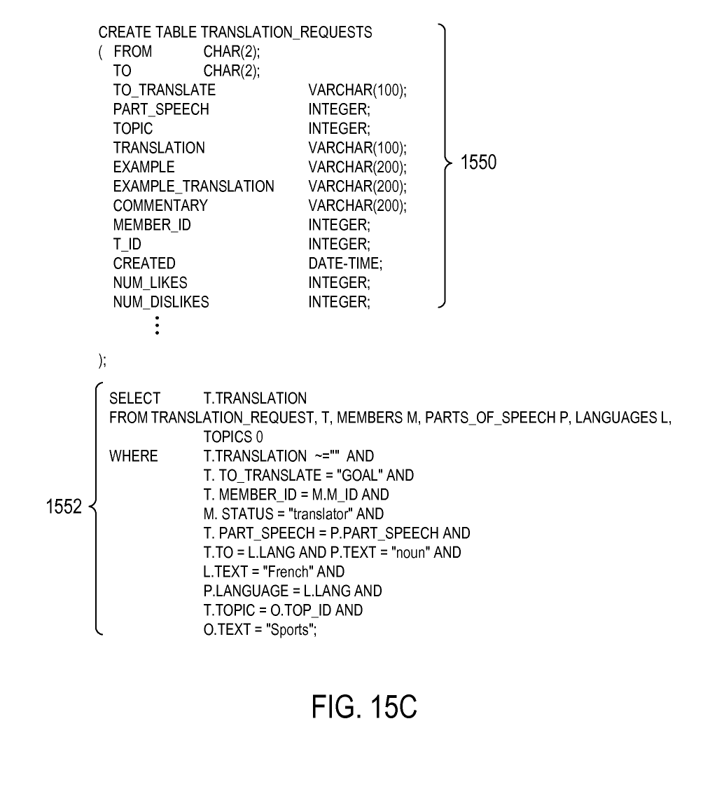

FIG. 15A illustrates computation of an initial rating for a posted translation, carried out by the call to the function “assign initial rating” in step 1488 of FIG. 14I. FIG. 15A shows one possible approach to computing an initial rating, but, there are many other ways to compute a numerical rating using different computational steps, factors, and considerations. As shown in a hybrid block/arithmetic form in FIG. 15A, the initial rating, in one implementation, is computed as the sum of five terms 1502-1506. Each term, in turn, is the product of a numeric factor and a weighting factor. For example, the first term 1502 is the product of a status and level-of-mastery factor 1508 and a weighting factor 1509. The weighting factors are used to assign relative importance or significance to the different numeric factors. In the following discussion, a first translation post is similar to a second translation post when the “word or phrase” and “translation” fields of the two posts are identical but other fields differ. A parallel text is a multi-part display in which text is placed alongside one or more translations of the text, and a parallel text is aligned when the corresponding sentences or phrases of the text and the one or more translations of the text are identified by alignment in the display or by other means. The five numeric factors include: (1) the status and level of mastery that characterizes the user providing the translation 1508; (2) the rating for the user who provided the translation 1510; (3) the frequency with which the proposed translation and similar translations are observed in aligned parallel texts 1512; (4) the frequency with which the proposed translation, or similar translations, are observed in standard references, such as licensed dictionaries 1514; and (5) the frequency with which the proposed translation, or similar translations, are observed in community posts 1516. The status and level of mastery of both the language of the word or phrase to be translated and the language to which the word or phrase is to be translated is a combination of numeric values for the status and level of mastery 1518. The different statuses that a user proposing a translation may have include: native speaker of the language, translator, teacher, professor, student of the language, or frequent user of the language. These different statuses may be assigned different relative numerical rankings for use in computing the overall rating as the sum of the five terms shown in FIG. 15A. Similarly, relative numeric values are assigned to different levels that a user proposing a translation may have, including beginner, elementary, pre-intermediate, intermediate, upper intermediate, and advanced. The higher the status and level of mastery, the larger the corresponding numeric value. The user-rating factor 1510 may combine numeric ratings assigned to the user based on a variety of considerations 1520 including the number of translations submitted by the user, the number of other types of posts submitted to the community by the user, the timeliness of responses by the user to requests made by other users, the “like”/“dislike” ratio for posts made by the user, the number of ratings of posts made by the user, and the number of references by other users to the user's posts. Many other such considerations may be involved in computing a numeric user rating. In certain implementations, for example, community members may rate users directly, via rating features associated with the users' profiles. The third factor 1512 is related to the frequency in which the word or phrase/translation pair is observed in aligned parallel texts 1522. In one implementation, a maximum number of observations is assigned a highest numerical factor, and subranges between 0 and this maximum number of observations are assigned decreasing numeric values. Similar comments apply to the fourth and fifth factors 1514 and 1516.

FIGS. 15B-C illustrate examples of relational database tables that may be used, in certain implementations, to store data within the distributed computing system that includes web servers that host the electronic community-based translation service web site. These are a small number of examples for an implementation that would include many additional tables and types of queries. As shown in FIG. 15B, the database implementation may include, among other tables, a translation_requests table 1520, a parts_of speech table 1522, a languages table 1524, a members table 1526, and a topics table 1528. Each row in the translation_requests table 1520, such as the first row 1530, includes entries for each of the multiple columns, or fields of the table, that together comprise the data that represents a request-for-translation post that can be later modified to include a proposed translation. For example, the first column, or field 1532 and the second column or field 1534 are named “from” and “to,” and include integer identifiers of the language of the word or phrase to be translated and the language to which the word or phrase is to be translated. The third column or field 1536 includes the word or phrase to be translated. Additional columns include indications of the part of speech of the word or phrase to be translated 1537, the general topic for the word or phrase 1538, a proposed translation for the word or phrase 1539, an example that includes the word or phrase 1540, a translation of the example 1541, commentary with respect to the request for translation 1542, the identifier of the member submitting the request for translation 1543, a unique identifier for the request for translation 1544, a date/time corresponding to the creation date and time of the request for translation 1545, the number of “likes” entered for the request for translation 1546, and the number of “dislikes” entered for the requested translation 1547. Many additional fields may be included. In many implementations, in order to accommodate multiple proposed translations, fields 1539-1543 may be replaced by an identifier that is used to identify each of a set of proposed translations stored in a different table. There are, of course, many different ways to implement a particular database using the structured query language (“SQL”).

FIG. 15C illustrates SQL expressions for table creation and for queries to extract data from the relational tables. The first expression 1550 is an SQL command to create the translation_requests table (1530 in FIG. 15B). The table-creation command lists each column of a table along with its data type. The second expression 1552 is a query that retrieves a translation from the translation_requests table. The retrieved translation cannot be blank, or empty, is a translation for the word “goal,” is provided by a community member having the status “translator,” is used as a noun, the translation is to an equivalent word in the French language, and the requested translation has the general topic “sports.”

FIGS. 15B-C are intended to illustrate the nature of relational databases and relational-database queries as an example of the type of data storage that may be used in the distributed computing system to implement the electronic community-based translation service. Many other types of data-storage technologies can be alternatively used in alternative implementations, including flat files, hierarchical, networked, and object-oriented databases, and hybrid databases. While SQL is convenient for expressing a variety of different types of data-extraction queries, data can be extracted programmatically as well as by other types of querying technologies.

Although the present invention has been described in terms of particular embodiments, it is not intended that the invention be limited to these embodiments. Modifications within the spirit of the invention will be apparent to those skilled in the art. For example, any of many different types of implementations of the electronic community-based translation service can be obtained by varying any of many different design and implementation parameters, including choice of hardware platforms, operating systems, virtualization technologies, communications protocols, modular organization, data structures, control structures, and other such design and implementation parameters. An electronic community-based translation service may provide many features in addition to those described above, including additional features that allow communications and data exchange between individual members, groups of members, and non-member visitors of the electronic-community-based translation-service user interface. While a web site and Internet-based interactive user interface is an attractive and efficient implementation, other online interfaces are possible.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An electronic community-based translation service comprising:
a data center that includes one or more computer systems, each having one or more processors, memory, and data-storage subsystems, one or more of the one or more computer systems electronically communicating with remote, processor-controlled user devices through a communications infrastructure;
stored instructions within the one or more computer systems that control the one or more computer systems to receive requests from the processor-controlled user devices and transmit responses to the requests to the processor-controlled user devices to provide, on the processor-controlled user devices, an interactive user interface through which request-for-translation posts, translation posts, and general posts are posted to the data center for subsequent distribution to the processor-controlled user devices, by the data center, as community posts,
community posts are received for display on display components of the processor-controlled user devices,
rating information is transmitted to the data center with respect to community posts for association with the community posts and subsequent distribution to the processor-controlled user devices, by the data center, as rating indications within or associated with community posts, and
information about community members is posted to the data center for subsequent distribution, by the data center, to the processor-controlled user devices.

2. The electronic community-based translation service of claim 1 wherein each request-for-translation post is a request for translation of a word or phrase from a first language to a second language and includes:
an identifier of a community member making the request;
an identifier of a language of the word or phrase; and
an identifier of a language into which a translation for the word of phrase is requested.

3. The electronic community-based translation service of claim 2 wherein each request-for-translation post further includes:
an indication of a part of speech; and
an indication of a topic.

4. The electronic community-based translation service of claim 2 wherein each request-for-translation post further includes:
an example of a use of the word or phrase; and
a comment.

5. The electronic community-based translation service of claim 1 wherein a request-for-translation post, when distributed by the data center to the processor-controlled user devices and displayed as a community post, includes:
a word or phrase for which a translation is requested;
an indication of the identity of the requestor;
an indication of a language of the word or phrase; and
an indication of a language into which a translation for the word of phrase is requested.

6. The electronic community-based translation service of claim 5 wherein the request-for-translation post, when distributed by the data center to the processor-controlled user devices and displayed as a community post, further includes one or more of:
an indication of the data and time when the request-for-translation was posted;
a topic;
a photograph of the requestor;
an indication of the cumulative rating for the request-for-translation post;
a comment;
an active display feature to which an input results in displaying translations posted in response to the request-for-translation post;
an active display feature to which an input results in applying a rating to the request-for-translation post;
an active display feature to which an input results in display of a translation-input form; and
an active display feature to which an input results in display of a comment-input field

7. The electronic community-based translation service of claim 1 wherein each translation post provides a translation of a word or phrase from a first language to a second language and includes:
the translation;
an identifier of a community member providing the translation;
an identifier of a language of the word or phrase; and
an identifier of a language into which a translation for the word of phrase is provided.

8. The electronic community-based translation service of claim 7 wherein each translation post further includes one or more of:
an indication of a part of speech;
an indication of a topic;
an example of a use of the word or phrase and its translation;
an indication of a request-for-translation post to which the translation post is a response; and
a comment.

9. The electronic community-based translation service of claim 1 wherein a translation post, when distributed by the data center to the processor-controlled user devices and displayed as a community post, includes:
a word or phrase;
a translation for the word or phrase;
an indication of the identity of the translator;
an indication of a language of the word or phrase; and
an indication of a language of the translation.

10. The electronic community-based translation service of claim 9 wherein the translation post, when distributed by the data center to the processor-controlled user devices and displayed as a community post, further includes one or more of:
an indication of the data and time when a corresponding request-for-translation post was posted;
an indication of the identity of the requestor who posted the corresponding request-for-translation post.
an indication of the data and time when the translation was posted;
a topic;
a photograph of the translator;
an indication of the cumulative rating for the translation post;
a comment;
an active display feature to which an input results in applying a rating to the translation post; and
an active display feature to which an input results in display of a comment-input field.

11. The electronic community-based translation service of claim 1 wherein a general post includes a comment or observation and an identifier of a community member providing the general post.

12. The electronic community-based translation service of claim 1 wherein the rating information transmitted to the data center with respect to community posts comprises one of:
an indication of like; and
an indication of dislike.

13. The electronic community-based translation service of claim 1 wherein the rating information transmitted to the data center with respect to community posts comprises one or more of:
a numerical rating;
a textual rating.

14. The electronic community-based translation service of claim 1 wherein information about community members that is distributed by the data center includes one or more of:
a name;
a status with respect to one or more languages;
a level of mastery of one or more languages;
a photograph;
translation-provision history; and
a rating.

15. The electronic community-based translation service of claim 1 wherein a community post is assigned an initial rating by the data center, the initial rating computed as the sum of multiple terms, each term the product of a numerical factor and weighting factor.

16. The electronic community-based translation service of claim 15 wherein the numerical factors include:
a numeric indication of the status and level of mastery that characterizes the translator;
a rating for the translator;
a frequency with which the proposed translation and similar translations are observed in aligned parallel texts;
a frequency with which the proposed translation, or similar translations, are observed in standard references, such as licensed dictionaries; and
a frequency with which the proposed translation, or similar translations, are observed in community posts.

17. The electronic community-based translation service of claim 16 wherein the status is selected from among:
native speaker of the language;
translator;
teacher;
professor;
student of the language; and
frequent user of the language.

18. The electronic community-based translation service of claim 16 wherein the level of mastery is selected from among:
beginner;
elementary;
pre-intermediate;
intermediate;
upper intermediate; and
advanced.

19. A method for assembling an electronic community related to language translation, the method comprising:
providing a data center that includes one or more computer systems, each having one or more processors, memory, and data-storage subsystems, one or more of the one or more computer systems electronically communicating with remote, processor-controlled user devices through a communications infrastructure;
providing instructions within the one or more computer systems that control the one or more computer systems to receive requests from the processor-controlled user devices and transmit responses to the requests to the processor-controlled user devices to provide, on the processor-controlled user devices, an interactive user interface; and
responding to user interaction with the interactive user interface to
receive request-for-translation posts, translation posts, and general posts for subsequent distribution to the processor-controlled user devices as community posts,
display community posts on display components of the processor-controlled user devices,
receive rating information with respect to community posts,
distribute rating information to the processor-controlled user devices,
receive information about community members, and
distribute information about community members to the processor-controlled user devices.

20. Computer instructions, stored in a physical data-storage device, that, when executed on one or more computers within a data center, control the data center to:
receive requests from processor-controlled user devices and transmit responses to the requests to the processor-controlled user devices to provide, on the processor-controlled user devices, an interactive user interface; and
respond to user interaction with the interactive user interface to
receive request-for-translation posts, translation posts, and general posts for subsequent distribution to the processor-controlled user devices as community posts,
display community posts on display components of the processor-controlled user devices,
receive rating information with respect to community posts,
distribute rating information to the processor-controlled user devices,
receive information about community members, and
distribute information about community members to the processor-controlled user devices.
